(19) United States
(12) Patent Application Publication
(10) Pub. No.: US 2014/0029580 A1
(43) Pub. Date: Jan. 30, 2014

(54) HANDOVER DEVICE AND METHOD FOR SERVICE CONTINUITY IN MBMS

(71) Applicants: Myung Cheul Jung, Seoul (KR); Ki Bum Kwon, Seoul (KR); Jae Hyun Ahn, Seoul (KR)

(72) Inventors: Myung Cheul Jung, Seoul (KR); Ki Bum Kwon, Seoul (KR); Jae Hyun Ahn, Seoul (KR)

(73) Assignee: Pantech Co., Ltd., Mapo-gu, Seoul (KR)

(21) Appl. No.: 14/112,845

(22) PCT Filed: Apr. 27, 2012
(86) PCT No.: PCT/KR2012/003325

§ 371 Date: Oct. 18, 2013

(30) Foreign Application Priority Data
Apr. 28, 2011 (KR) 10-2011-0040157

(51) Int. Cl. H04W 36/00

(52) U.S. Cl. CPC H04W 36/0066
USPC 370/331

(57) ABSTRACT

Disclosed are a handover device and method for service continuity in an MBMS. Disclosed is a terminal comprising: a transmission unit for transmitting to the terminal and a linked source base station, an MBMS service indicator including information indicating whether an MBMS service is being received, and information on the type of the MBMS service; and a reception unit for receiving from the source base station, an MBMS service response indicator for indicating that the MBMS service is transmitted from a target base station forming a new link with the terminal through a handover, and receiving the MBMS service from the target base station. The present invention enables continuous reception of the MBMS service when cell is changed due to movement while the terminal is receiving the MBMS service.

### CROSS-REFERENCE TO RELATED APPLICATIONS

This application is the National Stage Entry of International Application PCT/KR2012/003325, filed on Apr. 27, 2012, and claims priority from and the benefit of Korean Patent Application No. 10-2011-0040157, filed on Apr. 28, 2011, both of which are incorporated herein by reference in their entireties for all purposes as if fully set forth herein.

### BACKGROUND

1. Field

The present invention relates to wireless communication, and more particularly, to a handover device and a handover method for service continuity in a multimedia broadcast/multicast service (MBMS).

2. Discussion of the Background

Cellular is a concept proposed to overcome limitations of a service area, and limits of frequency and a subscriber capacity. The cellular is a system that provides communication coverage by converting a single high-output base station into a plurality of low-output base stations. That is, a mobile communication service area is divided into a plurality of small cell units to allocate different frequencies to adjacent cells, respectively and allow two cells which are significantly distant from each other and do not interfere with each other to spatially reuse a frequency by using the same frequency band.

Handover or handoff represents a function to continuously maintain a communication state by being automatically tuned to a new traffic channel of an adjacent communication service area when a user equipment deviates from a current communication service area (hereinafter, referred to as a source cell) to move to the adjacent communication service area (hereinafter, referred to as a target cell) as the user equipment moves. A user equipment that communicates with a specific base station is linked to another adjacent base station (hereinafter, referred to as a target base station) when a signal intensity becomes weak in the specific base station (hereinafter, referred to as a source base station). When the handover is achieved, a problem of call disconnection which occurs when the user equipment moves to the adjacent cell can be solved.

A multimedia broadcast/multicast service (MBMS) is a service that simultaneously transmits data packets to a plurality of users similarly or in the same manner as the existing cell broadcast service (CBS). However, the CBS is a low-speed message based service, but the MBMS aims at high-speed multimedia data transmission. Further, the CBS is not based on an Internet protocol (IP), but the MBMS is based on an IP multicast. An advantage of the MBMS is that when users of a predetermined level are present in the same cell, the users share a required resource (alternatively, a channel) to allow a plurality of users to receive the same multimedia data, thereby increasing efficiency of a radio resource and allowing the users to inexpensively use a multimedia service.

The MBMS uses a common channel called a multicast channel in order for a plurality of user equipments to efficiently receive data for one service. That is, dedicated channels are not allocated as many as user equipments that intend to the service in one cell but only one common channel is allocated, with respect to one service datum. The plurality of user equipments simultaneously receives the common channel to increase the efficiency of the radio resource.

### SUMMARY

An object of the present invention is to provide a handover device and a handover method for service continuity in an MBMS.

Another object of the present invention is to provide a handover device and a handover method for service continuity in an MBMS by using a handover procedure.

Yet another object of the present invention is to provide a handover device and a handover method for service continuity in an MBMS when handed over to different cells in the same MBSFN area.

Yet another object of the present invention is to provide a handover device and a handover method for service continuity in an MBMS when handed over to a different MBSFN area.

Yet another object of the present invention is to provide a handover device and a handover method for service continuity in an MBMS when handed over to an reserved cell.

Yet another object of the present invention is to provide a device and a handover method of transmitting a parameter used to provide continuity of an MBMS.

In accordance with an embodiment of the present invention, there is provided a user equipment receiving a multimedia broadcast multicast service (MBMS). The user equipment includes: a transmitting unit transmitting an MBMS service indication including information representing whether a user equipment receives an MBMS and information regarding a type of the MBMS, to a source base station (eNB) linked with the user equipment; and a receiving unit receiving an MBMS service response indication indicating that the MBMS is transmitted from a target base station (target eNB) newly linked with the user equipment from the source base station by handover and receiving the MBMS from the target base station.

In accordance with another embodiment of the present invention, there is provided a method for receiving an MBMS by a user equipment. The receiving method includes: transmitting an MBMS service indication including information representing whether a user equipment receives an MBMS and information regarding a type of the MBMS, to a source base station linked with the user equipment; receiving an MBMS service response indication indicating that the MBMS is transmitted from a target base station newly linked with the user equipment from the source base station by handover; and receiving the MBMS from the target base station.

In accordance with another embodiment of the present invention, there is provided a target base station transmitting an MBMS. The target base station includes: a receiving unit receiving an MBMS control request indication including information representing whether a user equipment receives the MBMS and information regarding a type of the MBMS, from a source base station linked with the user equipment; a control unit judging whether to continuously support the MBMS to the user equipment based on the MBMS control request indication and determining whether to transmit the MBMS through a radio bearer for the MBMS; and a transmitting unit transmitting an MBMS service start indication indicating that the MBMS is supported to the user equipment and transmitting the MBMS under the same condition as the source base station.

In accordance with yet another embodiment of the present invention, there is provided a method for transmitting an MBMS by a target base station. The transmitting method includes receiving an MBMS control request indication including information representing whether a user equipment receives the MBMS and information regarding a type of the MBMS, from a source base station linked with the user equipment; judging whether to continuously support the MBMS to the user equipment based on the MBMS control request indication; determining whether to transmit the MBMS through a radio bearer for the MBMS; transmitting an MBMS service start indication indicating that the MBMS is supported to the user equipment; and transmitting the MBMS under the same condition as the source base station.

When a cell is changed as a user equipment moves while receiving an MBMS, the MBMS can be continuously received.

### BRIEF DESCRIPTION OF THE DRAWINGS

FIG. 1 is a block diagram illustrating a wireless communication system.

FIG. 2 is a block diagram illustrating a radio protocol architecture for a user plane and a radio protocol structure for a control plane.

FIG. 3 illustrates mapping between a downlink logic channel and a downlink transport channel.

FIG. 4 illustrates mapping between the downlink transport channel and a downlink physical channel.

FIG. 5 is a flowchart describing a handover method for service continuity in an MBMS according to an exemplary embodiment of the present invention.

FIG. 6 is one example of a general scenario applied with the handover method for service continuity in the MBMS according to the present invention.

FIG. 7 is a flowchart describing a handover method for service continuity in an MBMS according to another exemplary embodiment of the present invention.

FIG. 8 is another example of the general scenario applied with the handover method for service continuity in the MBMS according to the present invention.

FIG. 9 is a flowchart describing a handover method for service continuity in an MBMS according to yet another exemplary embodiment of the present invention.

FIG. 10 is yet another example of the general scenario applied with the handover method for service continuity in the MBMS according to the present invention.

FIG. 11 is a flowchart describing a handover method for service continuity in an MBMS, which is performed by a user equipment according to an exemplary embodiment of the present invention.

FIG. 12 is a flowchart describing a handover method for service continuity in an MBMS, which is performed by a source base station according to an exemplary embodiment of the present invention.

FIG. 13 is a flowchart describing a handover method for service continuity in an MBMS, which is performed by a target cell according to an exemplary embodiment of the present invention.

FIG. 14 is a block diagram illustrating the user equipment, the source base station, and the target base station that perform the handover method for service continuity in the MBMS according to an exemplary embodiment of the present invention.

### DETAILED DESCRIPTION OF THE ILLUSTRATED EMBODIMENTS

Herein, some embodiments will be described in detail with reference to the accompanying drawings in the present invention. When reference numerals refer to components of each drawing, it is noted that although the same components are illustrated in different drawings, the same components are referred to by the same reference numerals as possible. In describing the embodiments of the present invention, when it is determined that the detailed description of the known art related to the present invention may obscure the gist of the present invention, the detailed description thereof will be omitted.

Further, a wireless communication network is described as target in the specification, and a work performed in the wireless communication network may be performed while a system (for example, a base station) that controls the corresponding wireless communication network controls the network and transmits data, or the work may be performed by a user equipment coupled with the corresponding wireless network.

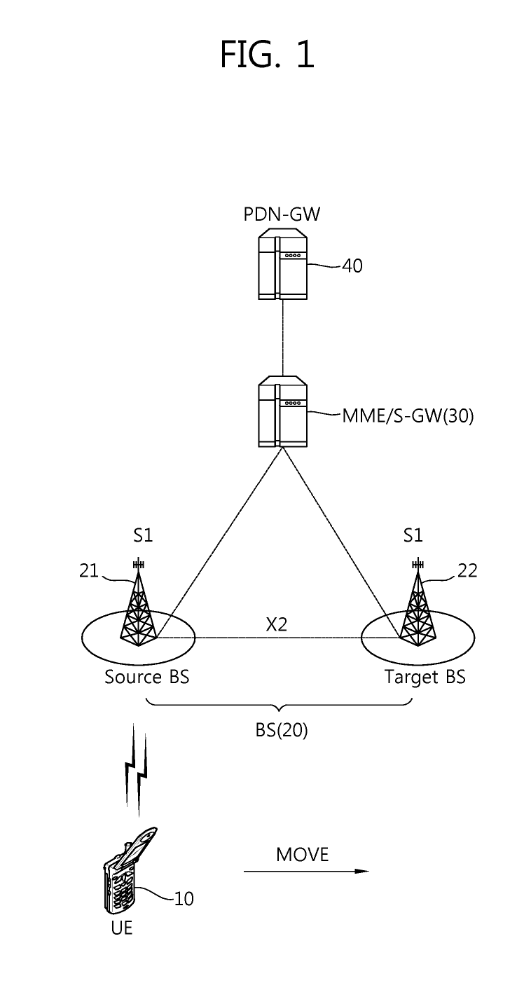

FIG. 1 is a block diagram illustrating a wireless communication system. This may be a network architecture of an evolved-universal mobile telecommunications system (E-UMTS). The E-UMTS may be called a long term evolution (LTE) or LTE-advanced (A) system. The wireless communication system is widely disposed to provide various communication services such as voice, packet data, and the like.

Meanwhile, there is no limit in a multiple access technique applied to the wireless communication system. Various multiple access techniques may be used, such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and OFDM-CDMA.

Herein, a time division duplex (TDD) technique in which transmission is performed by different times may be used or a frequency division duplex (FDD) technique in which transmission is performed by using different frequencies may be used, in uplink transmission and downlink transmission.

Referring to FIG. 1, an E-UTRAN includes at least one base station (BS) 20 that provides a control plane and a user plane to a user equipment. A user equipment (UE) 10 may be fixed or movable and may be called other terms such as a mobile station (MS), an advanced MS (AMS), a user terminal (UT), a subscriber station (SS), a wireless device, and the like.

The base station 20 generally indicates a point (station) that communicates with the user equipment 10, and may be called other terms evolved-nodeB (eNodeB), a base transceiver system (BTS), an access point, a femto base station (femto-Enb), a pico base station (pico_Enb), a home base station (Home Enb), a relay, and the like. The base station 20 may provide at least one cell to the user equipment. The cell may mean a geographical area that provides a communication service or mean a specific frequency band. The cell may mean a downlink frequency resource and an uplink frequency resource. Alternatively, the cell may mean a combination of the downlink frequency resource and an optional uplink frequency resource. Further, in general, when carrier aggregation (CA) is not considered, the uplink and downlink frequency resources are present as a pair in one cell.

An interface for transmitting user traffic or control traffic may be used between the base stations 20. A source base station (BS) 21 means a base station which sets a radio bearer with the current user equipment 10 and the target BS 22 means a base station to which the user equipment 10 cuts the radio bearer with the source BS 21 and intends to perform handover in order to newly set the radio bearer.

The base stations 20 may be connected to each other through an X2 interface and the X2 interface is used to transmit and receive a message between the base stations 20. The base station 20 is connected with an evolved packet system (EPS), more particularly, a mobility management entity (MME)/serving gateway (S-GW) 30 through an S1 interface. The S1 interface supports a many-to-many relation between the base station 20 and the MME/S-GW 30. A PDN-GW 40 is used to provide a packet data service to the MME/S-GW 30. The PDN-GW 40 depends on a purpose or a service of communication and the PDN-GW 40 that supports a specific service may be found by using access point name (APN) information.

Inter E-UTRAN handover as a basic handover mechanism used in handover between E-UTRAN access networks is constituted by X2-based handover and S1-based handover. The X2-based handover is used when the UE intends to hand over the source BS 21 to the target BS 22 by using the X2 interface and in this case, the MME/S-GW 30 is not changed.

A first bearer set among the P-GW 40, the MME/S-GW 30, the source base station 21, and the user equipment 10 is released by the S1-based handover, and a new second bearer is set among the P-GW 40, the MME/S-GW 30, the target base station 22, and the user equipment 10.

Hereinafter, a downlink means communication from the base station 20 to the user equipment 10 and an uplink means communication from the user equipment 10 to the base station 20. The downlink may be called a forward link and the uplink may be called a reverse link. In the downlink, a transmitter may be a part of the base station 20 and a receiver may be a part of the user equipment 10. In the uplink, the transmitter may be a part of the user equipment 10 and the receiver may be a part of the base station 20.

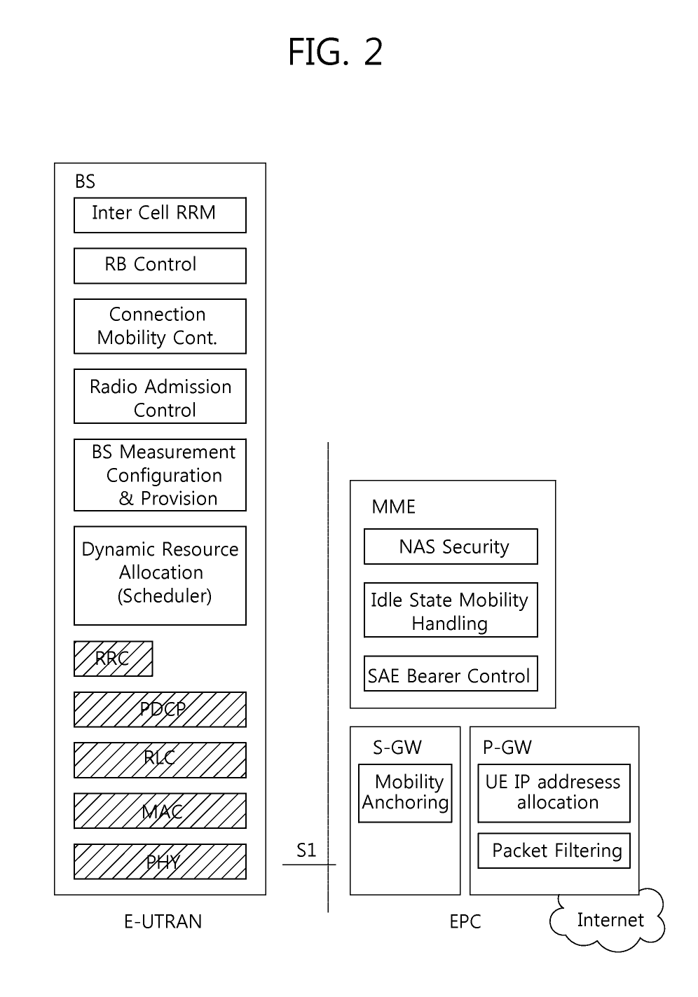

FIG. 2 is a block diagram illustrating a radio protocol architecture for a user plane and a radio protocol structure for a control plane. The data plane is a protocol stack for user data transmission and the control plane is a protocol stack for transmitting a control signal.

Referring to FIG. 2, a physical (PHY) layer provides information transfer service to an upper layer by using a physical channel. The physical layer is connected with a medium access control (MAC) layer as the upper layer through a transport channel. Data move between the MAC layer and the physical layer through the transport channel. The transport channel is classified depending on a transmission method and a transmission feature through a radio interface. In addition, data moves between different physical layers, that is, between the physical layers of the transmitter and the receiver through the physical channel. There are several physical control channels. A physical downlink control channel (PDDCCH) notifies resource allocation of a paging channel (PCH) and a downlink shared channel (DL-SCH) and hybrid automatic repeat request (HARQ) information associated with the DL-SCH to the user equipment. The PDCCH may transport an uplink scheduling grant to notify resource allocation of the uplink transmission. A physical control format indication channel (PCFICH) notifies the number of OFDM symbols used in the PDCCHs to the user equipment, which is transmitted every subframe. A physical hybrid ARQ indication channel (PHICH) transports an HARQ ACK/NAK signal as a response of the uplink transmission. A physical uplink control channel (PUCCH) transports uplink control information such as HARQ ACK/NAK, a scheduling request, a CQI for the downlink transmission. A physical uplink shared channel (PUSCH) transports an uplink shared channel (UL-SCH).

A function of the MAC layer includes mapping between the logic channel and the transport channel, and multiplexing/demultiplexing to a transport block provided to the physical channel onto the transport channel of an MAC service data unit (SDU) that belongs to the logical channel. The MAC layer provides a service to a radio link control (RLC) layer through the logic channel. The logic channel may be divided into a control channel for transferring control area information and a traffic channel for transferring user area information.

A function of the RLC layer includes concatenation, segmentation, and reassembly of an RLC SDU. In order to assure various quality of services (QoS) requested by a radio bearer (RB), the RLC layer provide three types of operating modes of a transparent mode (TM), an unacknowledged mode (UM), and an acknowledged mode (AM). An AM RLC provides error correction through an automatic repeat request (ARQ).

A function of a packet data convergence protocol (PDCP) layer on the user plane includes transferring of user data, header compression, and ciphering. A function of a packet data convergence protocol (PDCP) layer on the user plane includes transferring of user data, header compression, and ciphering.

An RRC layer serves to control the transport channels and the physical channels in association with configuration, re-configuration, and release of radio bearers. The RB means a logic route provided by the first layer (PHY layer) and the second layers (the MAC layer, the RLC layer, and the PDCP layer) in order to transfer data between the networks. Setting the RB defines features of the radio protocol layer and channel in order to provide a specific service and means a process of setting respective detailed parameters and operating methods. The RB may be divided into a signaling RB (SRB), a data RB (DRB), and an MBMS PTM RB (MRB) again. The SRB is used as a passage for transmitting an RRC message on the control plane and the DRB is used as a passage for transmitting the user data on the user plane. The MRB is used as a passage for transmitting MBMS data.

A non-access stratum layer located above the RRC layer performs functions such as session management and mobility management.

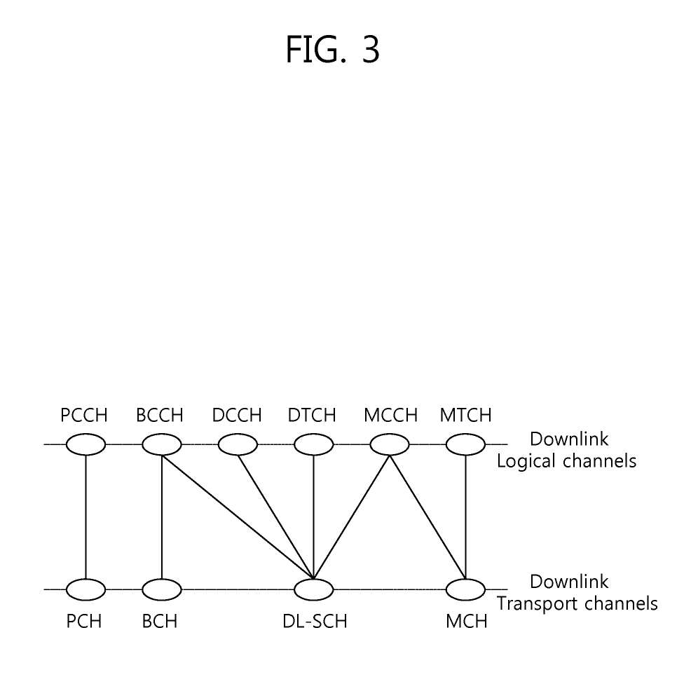

FIG. 3 illustrates mapping between a downlink logic channel and a downlink transport channel.

Referring to FIG. 3, the paging control channel (PCCH) is mapped to the paging channel (PCH), and a broadcast control channel (BCCH) is mapped to a broadcast channel (BCH) or the downlink shared channel (DL-SCH). A common control channel (CCCH), a dedicated control channel (DCCH), a dedicated traffic channel (DTCH), a multicast control channel (MCCH), and a multicast traffic channel (MTCH). The MCCH and the MTCH are mapped to even a multicast channel (MCH).

Each logic channel type is defined by considering what type of information is transmitted. The logic channel includes two types of the control channel and the traffic channel.

The control channel is used to transmit control plane information. The BCCH is a downlink channel for broadcasting system control information. The PCCH as a downlink channel for transmitting paging information is used when the network does not know the location of the user equipment. The CCCH as a channel for transmitting control information between the user equipment and the network is used when the user equipment is not RRC-connected with the network. The MCCH as a point-to-multipoint downlink channel used to transmit the MBMS control information is used for user equipments that receive the MBMS. The DCCH as a point-to-point unidirectional channel for transmitting dedicated control information between the user equipment and the network is used by a user equipment which is RRC-connected.

The traffic channel is used for transmitting the user plane information. The DTCH is a point-to-point channel for transmitting the user information and is present in both the uplink and the downlink. The MTCH is a point-to-multipoint downlink channel for transmitting the traffic data and is used for the user equipment that receives the MBMS.

The transport channel is classified depending on the transmission method and the transmission feature through the radio interface. The BCH has a predetermined transmission format that is broadcasted and fixed in the entire cell area. The DL-SCH has features of supporting, modulation, coding, and supporting of dynamic link adaptation by a change in transmission power of the hybrid automatic repeat request (HARM), a possibility of the broadcast, a possibility of beam forming, supporting of dynamic/semi-static resource allocation, supporting of discontinuous reception (DRX) for saving user equipment power, and supporting of MBMS transmission. The PCH has features of the supporting of discontinuous reception (DRX) for saving user equipment power and the broadcast in the entire cell area. The MCH has features of the broadcast in the entire cell area and supporting of the MBMS single frequency network (MBSFN). The MBSFN is a scheme that uses a common scrambling code and a spreading code in order to broadcast the same MBMS channel simultaneously in a plurality of cells constituting an MBMS cell group.

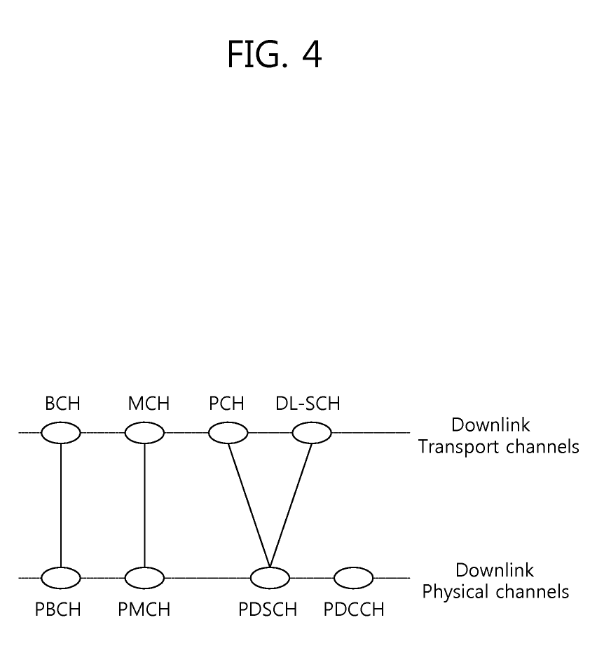

FIG. 4 illustrates mapping between the downlink transport channel and a downlink physical channel.

Referring to FIG. 4, the BCH is mapped to the physical broadcast channel (PBCH), the MCH is mapped to the physical multicast channel (PMCH), and the PCH and the DL-SCH are mapped to the PDSCH. The PBCH transports the BCH transport block, the PMCH transports the MCH, and the PDSCH transports the DL-SCH and the PCH.

The MBMS uses two logic channels. Two logic channels include the MCCH as the control channel and the MTCH as the traffic channel. User data such as actual audio or video is transmitted onto the MTCH and setting information for receiving the MTCH is transmitted onto the MCCH. The MTCH and the MCCH may be the point-to-multipoint downlink channels for a plurality of user equipments and may be the common channels. In the MBMS, the radio resources are not allocated as many as user equipments that receive the service but only the radio resource is allocated to the common channel and the plurality of user equipments simultaneously receives the common channel, thereby increasing the efficiency of the radio resource.

When the user equipment changes the cell with positional movement while receiving the MBMS, the user equipment may not continuously receive the MBMS. Even in such a status, the user equipment performs a decoding operation in order to continuously receive the MBMS, thereby causing a battery to be consumed. A device and a method that are capable of consecutively receiving the MBMS without wasting the resource are required when the user equipment that uses the MBMS performs the handover.

A source cell means a cell in which the current user equipment receives the service. A base station that provides the source cell is called a source base station. A neighboring cell means a cell that is adjacent to the source cell geographically or on the frequency band. A neighboring cell that uses the same band or frequency based on the source cell is called an intra-frequency neighboring cell. Further, a neighboring cell that uses different a different band or frequency based on the source cell is called an inter-frequency neighboring cell. That is, as the cell using the same band or frequency as the source cell and the cell using the different band or frequency, all cells that are adjacent to the source cell may be called the neighboring cell.

Handover of the user equipment from the source cell to the intra-frequency neighboring cell is called intra-frequency handover. Meanwhile, handover of the user equipment from the source cell to the inter-frequency neighboring cell is called inter-frequency handover. A neighboring cell to which the user equipment moves in handover is called a target cell. In addition, a base station that provides the target cell is called a target base station.

The source cell and the target cell may be provided by one base station or different base stations. Hereinafter, the handover will be described on the assumption that the source cell and the target cell are provided by different base stations, that is, the source base station and the target base station for easy description. Therefore, the source base station and the source cell, and the target base station and the target cell may be mixedly used.

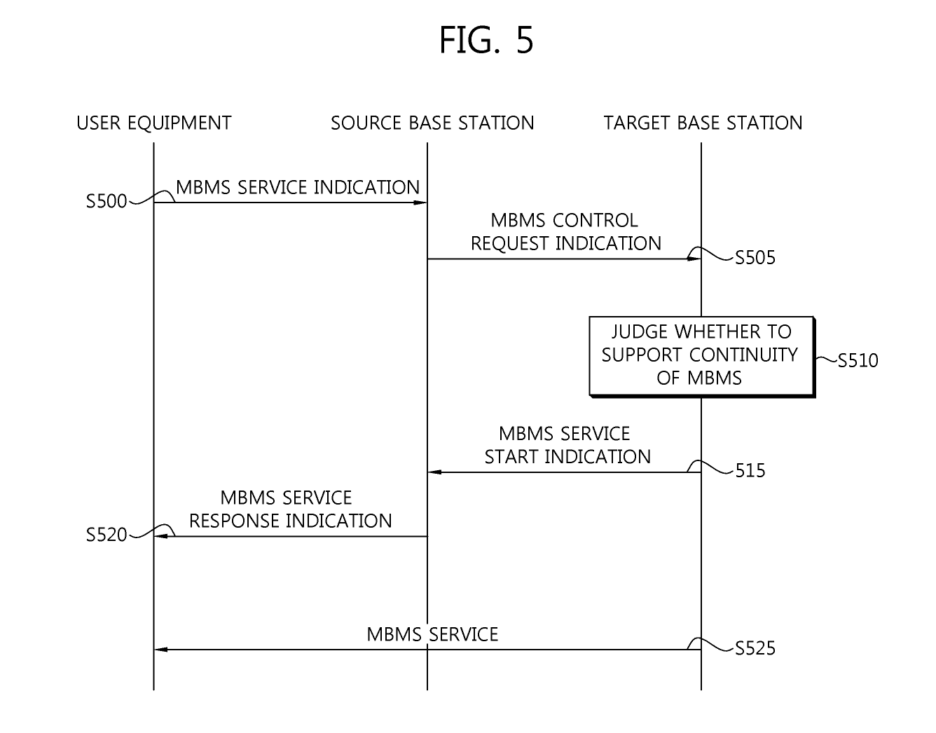

FIG. 5 is a flowchart describing a handover method for service continuity in an MBMS according to an exemplary embodiment of the present invention.

Referring to FIG. 5, the user equipment transmits an MBMS service indication to the source base station (S500). As one example, the MBMS service indication is an indication that notifies whether the user equipment receives the MBMS through the MRB. For example, a form of the MBMS service indication is a flag and the MBMS service indication may indicate 0 or 1. When the MBMS service indication is 1, the user equipment receives the MBMS and when the MBMS service indication is 0, the user equipment does not receive the MBMS. Herein, even though the user equipment receives at least one MBMS among a plurality of MBMSs, the MBSM indication may be set to 1.

As another example, the MBMS service indication may include MBMS interest information indicating whether the user equipment takes an interest in receiving the MBMS. If the MBMS interest information indicates the interest in receiving the MBMS, the target base station may find that the user equipment takes an interest in receiving the MBMS. The MBMS interest information may be configured in a flag form. For example, when the MBMS interest information is 1, it is indicated that the user equipment takes an interest in receiving the MBMS and when the MBMS interest information is 0, it is indicated that the user equipment does not take an interest in receiving the MBMS. When it is judged that the user equipment takes an interest in receiving the MBMS, the target base station may perform the MBMS and when there is an MBMS desired by the user equipment, the user equipment may receive the MBMS through the MRB. Alternatively, when the MBMS may be received by the MRB and a dedicated radio bearer, the MBMS needs to be received through the MRB.

Further, when the MBMS interest information is 1 in the case where the user equipment does not receive the current MBMS through the MRB, the target base station needs to perform scheduling by taking the priority so that the user equipment receive the MBMS through the MRB.

As yet another example, the MBMS service indication may be an indication that indicates a type of the MBMS received by the user equipment. The reason is that the user equipment may simultaneously receive a plurality of MBMSs, MBMS service areas or MBSFN areas for the respective MBMSs may be different from each other, and the MBMS which is performed at a location at which the current user equipment receives the MBMS needs to be notified. The type of the MBMS may be distinguished by a temporary mobile group identity (TMGI) for the MBMS.

For example, the MBMS service indication may be configured in a list form like TMGI A, B, and C when the plurality of MBMS user equipments receives MBMSs A, B, and C. Alternatively, one MBMS service indication may indicate a type of one MBMS. That, the MBMS type may be individually configured and transmitted by the MBMS service indication. For example, it may be configured in such a manner that MBMS service indication 1=TMGI A, MBMS service indication 2=TMGI B, and MBMS service indication 3=TMGI C.

Alternatively, the MBMS service indication may include information regarding the MBMS type and the MBMS interest information indicating whether the user equipment takes an interest in receiving each type of MBMS. For example, the MBMS service indication may represent whether the user equipment takes an interest receiving the MBMS for each MBMS as the flag in such a manner of {MBMS type=TMGI A, MBMS interest information=1}, {MBMS type=TMGI B, MBMS interest information=0}, and {MBMS type=TMGI C and MBMS interest information=1}. Herein, in the MBMSs A and C, since the MBMS interest information is 1, the target base station needs to preferentially set the MBMS by the MRB after the handover. On the contrary, in the case of the MBMS B, the MBMS may be set by the MRB at a lower priority than other A and C.

As yet another example, the MBMS service indication may indicate the MBMS type and whether to receive the MBMS. That is, the MBMS service indication indicates all types of MBMSs as well as indicating whether to receive the MBMS as the flag.

The MBMS service indication may be included in a message used in a handover procedure, for example, a measurement reporting message. Alternatively, the MBMS service indication may be included in a separate message associated with the handover procedure.

The source base station transmits an MBMS control request indication to the target base station (S505). The MBMS control request indication is information in which the source base station requests controlling the MBMS to the target base station in order to assure MBMS continuity of the user equipment and may include the same form or the same information as the MBMS service indication. For example, the MBMS control request indication may indicate whether the user equipment receives the MBMS. Alternatively, the MBMS control request indication may indicate the type of the MBMS received by the user equipment. Alternatively, the MBMS control request indication may include the MBMS interest information. The target base station may find whether the user equipment takes an interest in receiving the MBMS according to the indication of the MBMS interest information. The MBMS control request indication may be information defined in the X2 interface. The MBMS control request indication may be included in an handover request message or one independent message which is apart from the handover request message.

Therefore, the MBMS control request indication may be configured as below.

{
MBMS interest information : 1 or 0
MBMS TMGI = A, TMGI = B, TMGI = C
}

In such a case, the MBMS interest information may correspond to all MBMSs and after the target base station verifies that the MBMS interest information corresponds to all of the MBMSs, the user equipment may perform scheduling so as to use the MBMS through the MRB by considering situations of the respective MBMSs.

Alternatively, the MBMS control request indication may be configured as below.

{
MBMS TMGI= A, MBMS interest information: 1 or 0
MBMS TMGI= B, MBMS interest information: 1 or 0
MBMS TMGI= C, MBMS interest information: 1 or 0
}

In such a case, the MBMS interest information may be set differently for each MBMS. Therefore, the MBMS interest information may be differently applied to the respective MBMSs. The target base station verifies the received MBMS and MBMS interest information and prefers a service in which the MBMS interest information is set to 1 among the MBMSs to set and schedule the MBMS.

The target base station judges whether to support the continuity of the MBMS for the user equipment based on the MBMS control request indication (S510). Herein, judging whether to support the continuity of the MBMS includes judging whether the user equipment is a user equipment that receives the MBMS. When the user equipment is the user equipment that receives the MBMS, the target base station determines supporting the continuity of the MBMS of the user equipment. On the contrary, when the user equipment is not a user equipment that does not receive the MBMS, the target base station does not determine supporting the continuity of the MBMS of the user equipment.

Alternatively, judging whether to support the continuity of the MBMS includes judging whether providing the MBMS itself is possible or impossible.

Alternatively, when the target base station is changed, judging whether to support the continuity of the MBMS includes judging what cell, component carrier, or frequency the target base station provides each MBMS through. The reason is that a specific MBMS may be supported by only specific cell, component carrier, or frequency. The carrier aggregation (CA) which supports a plurality of carriers may be called spectrum aggregation or bandwidth aggregation. Individual unit carriers which are tied by the carrier aggregation are called the component carrier (hereinafter, referred to as CC). In order to transmit and receive the packet data through a specific cell, the user equipment needs to first configure the specific cell or CC. Herein, the configuration means a state in which receiving system information required for data transmission and reception for the corresponding cell or CC is completed. In handover considering the carrier aggregation, both a main serving cell and a sub serving cell need to be considered. For example, when the main serving cell is changed to the sub serving cell in the same base station, the handover is intra BS or intra eNB handover and when the main serving cell is changed to a specific cell in another base station, the handover is inter BS or inter eNB handover.

Alternatively, judging whether to support the continuity of the MBMS includes judging the type of the MBMS received by the user equipment. The reason is that there may be present an MBMS which the target cell or the target base station is capable of supporting or there may be present an MBMS which the target cell or the target base station is incapable of supporting.

The target base station transmits an MBMS service start indication to the source base station (S515). The MBMS service start indication indicates whether the target base station supports the MBMS. Herein, the MBMS may include a service supported through the RB in addition to the service supported through the MRB. The MBMS service start indication may be transmitted with being included in a handover request response message or transmitted with being included in a separate independent message therefrom.

As one example, the MBMS service start indication may indicate only whether to support the MBMS. For example, the target base station judges whether to support the continuity of the MBMS and when it is judged that the user equipment uses the MBMS, the target base station sets the MBMS service start indication to 1. This indicates that the target base station may continuously support the MBMS for the user equipment. That is, this means that the user equipment may receive the MBMS in the serving cell similarly to the MRB. On the contrary, the target base station judges whether to support the continuity of the MBMS and when it is judged that the user equipment does not use the MBMS, the target base station sets the MBMS service start indication to 0. This means that the target base station may not continuously support the MBMS for the user equipment.

As another example, the MBMS service start indication may include information on a cell, a CC, or a frequency to be used to provide the MBMS to the user equipment.

As yet another example, the MBMS service start indication may include information regarding the type for the MBMS received by the user equipment and a cell, a CC, or a frequency which the target base station may support for each MBMS as described in Table 1.

TABLE 1

| MBMS type | TMGI | enable/disable | Frequency |
|---|---|---|---|
| MBMS 1 | A | enable | CC1 |
| MBMS 2 | B | disable | CC2 |
| MBMS 3 | C | enable | CC3 |

Referring to Table 12, the MBMS service start indication includes the TMGI to identify each MBMS, and information regarding whether the target base station is enabled or disabled to support the corresponding MBMS and frequency bands (CC1, CC2, CC3, and the like).

The source base station transmits an MBMS service response indication to the user equipment (S520). The MBMS service response indication may be included in a handover command message or be a separate independent message. The user equipment may obtain information regarding whether the user equipment is enabled or disabled to receive the MBMS from the target base station by using information included in the MBMS service response indication, and the cell, CC, or frequency in which the MBMS is provided.

The target base station transmits the same MBMS which the user equipment receives from the source base station to the user equipment (S525). The user equipment may receive the MBMS from the target base station by using the MBMS information in a specific cell or at a specific frequency in the target base station for each MBMS.

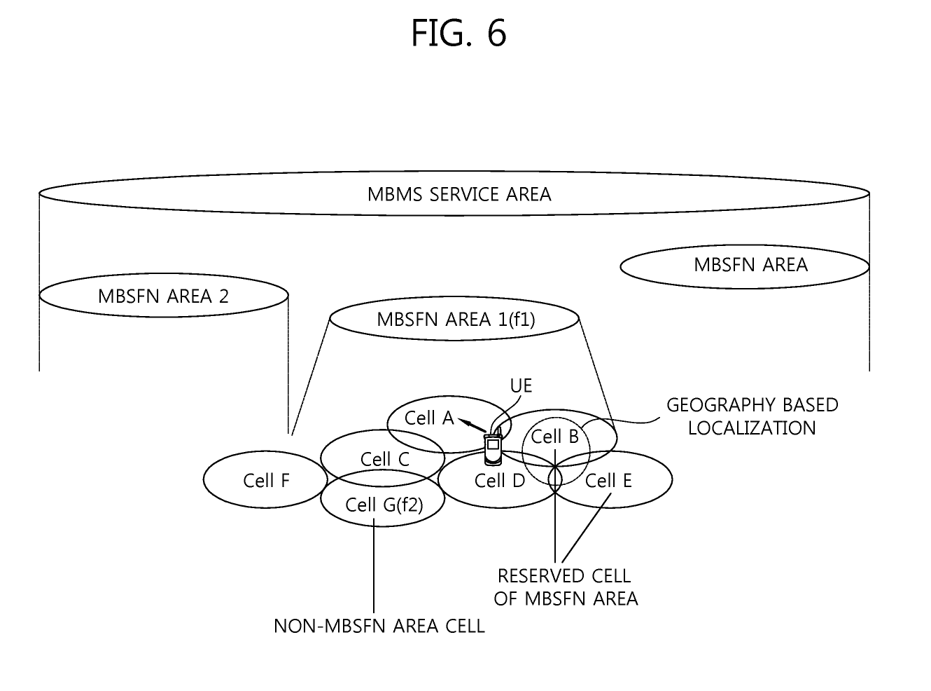

FIG. 6 is one example of a general scenario applied with the handover method for service continuity in the MBMS according to the present invention. The MBMS may be managed based on the cell or the location. The MBMS service area is a term that represents an area in which a specific MBMS is provided. For example, when it is assumed that an area in which specific MBMS A is provided is set as MBMS service area A, a network in the MBMS service area A may transmit the MBMS A. In this case, the user equipment may receive the MBMS A in accordance with a capability of the user equipment or may not be so. The MBMS service area may be defined in terms of an application and a service regarding whether a specific service is provided or not.

Cells A, B, C, D, and E are included in the MBSFN area. Cell G is not the cell of the MBSFN area but a cell in which the service is provided at a different frequency band f2. The MBSFN area means an area in which a specific MBMS is provided at a single frequency band. For example, in the case of MBSFN area 1, the specific MBMS A is supported in an MBSFN subframe at a frequency f1. In the case of even MBSFN area 2, the MBMS A is supported, herein, the MBMS A may be supported by using f2 different from the frequency resource f1 in the MBSFN area. In the same MBSFN area, the user equipment may receive the MBMS based on the same MBMS configuration even while moving. In other words, the user equipment may continuously receive the MBMS that the user equipment receives in the previous cell without an operation of receiving a new MBMS configuration in the same MBSFN area.

The cell B and the cell E are included in the MBSFN area 1, but is a reserved cell that does not transmit the MBMS under a specific situation. For example, user equipments that use the MBMS are concentrated on another area, and as a result, the number of user equipments that receive the MBMS by using the MRB may be very small in the cell B. In this case, it is not preferable that the cell B supports the service through the MRB in terms of radio efficiency. Therefore, the cell B may support the MBMS through a dedicated bearer or a specific user equipment or the point-to-point bearer.

Alternatively, the MBMS may be limitedly supported so as to provide a specific MBMS in only a specific area. In other words, as one example of the location based service, a specific MBMS is supported in only a specific area and the specific MBMS may not be supported in an area other than the specific area. Even in this case, an area or a cell in which the specific MBMS is supported may be changed. In this case, management of the reserved cell may be used as one method for managing the MBMS service area itself as well as in terms of the radio efficiency.

The reserved cell may be defined as a cell in which the current MBMS is not provided through the MRB. In this case, the reserved cell may the cell that never supports the current MBMS or a cell that the supports the MBMS, but supports the MBMS through not the MRB but the dedicated bearer.

The reserved cell is included in the MBSFN area 1 together with other cells that provide the MBMS. In a general case, the cells in the MBSFN is configured to use the same MBSFN subframe for the MBMS and it may be regarded that the MBMS is continuously transmitted to all of the cells in the MBSFN area for the MBMS. However, in a case in which the service is supported through the MRB at a localized position smaller than the area defined as the MBSFN or in a special case in which only a small number of user equipments is anticipated to receive the MBMS in a specific area, it is efficient to support the MBMS through not the MRB but the dedicated bearer. Therefore, the cells B and E are the cells in the same MBSFN area as the cells A, C, and D, but the cells B and E may not provide the MBMS through the MRB.

The reserved cell may be determined based on an MBMS location range. The MBMS location range is a concept used to perform a management in such a manner that all of the cells in the existing MBSFN area may receive the MBMS through the MRB, while the MBMS may be received through the MRB only a specific area or location range even within the same MBSFN area. In this case, the MBMS location range may be managed by the unit of the cell or managed by a method of geography or accurate area based localization, for example, a positioning method.

Referring to FIG. 6, the user equipment UE receives the MBMS in the cell D of the specific MBSFN area 1 in the MBMS service area. The user equipment may move from the cell D to the cell A and in this case, the cell D and the cell A are the serving cell and the target cell described in FIG. 5, respectively. Since the cell A is positioned in the same MBSFN area as the cell D, the user equipment may continuously receive the MBMS by using the same MBSFN subframe even after moving to the cell A according to the handover method for the service continuity in the MBMS.

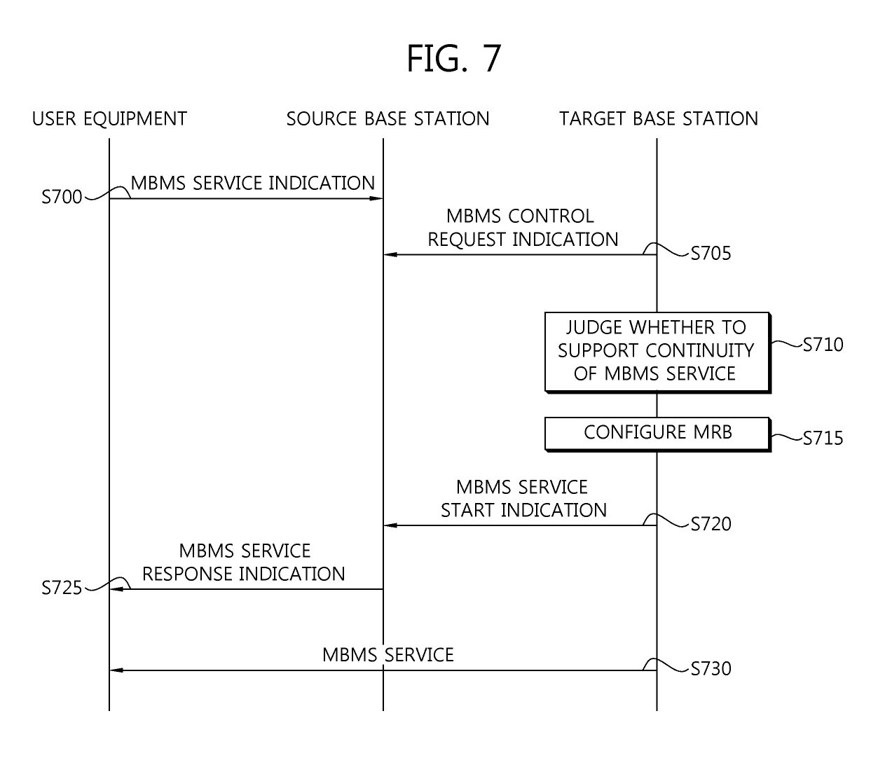

FIG. 7 is a flowchart describing a handover method for service continuity in an MBMS according to another exemplary embodiment of the present invention. In this case, the target cell is the reserved cell.

Referring to FIG. 7, the user equipment transmits the MBMS service indication to the source base station (S700). Herein, the MBMS service indication includes a content of the MBMS service indication depending on step S500 of FIG. 5. The source base station transmits the MBMS control request indication to the target base station (S705). Herein, the MBMS control request indication includes a content of the MBMS control request indication described in step S505 of FIG. 5.

The target base station judges whether to support the continuity of the MBMS for the user equipment based on the MBMS control request indication (S710). Herein, a method of judging whether to support the continuity of the MBMS includes step S510 of FIG. 5. Additionally, judging whether to support the continuity of the MBMS may further include judging whether the MBMS is provided through the dedicated bearer (point-to-point bearer) or the MRB. The target base station may configure not the dedicated bearer but the MRB and provide the MBMS by using the MBSFN subframe when the number of the user equipments that receive the MBMS is equal to or more than a specific threshold. For example, it is assumed that the specific threshold is 10 (UEs). When the number of user equipments is 10 with the movement of the user equipments, it is preferable in terms of the radio efficiency that the target base station provides the MBMS by using the MRB rather than the dedicated bearer. Therefore, the target base station configures the MRB for the MBMS (S715).

The target base station transmits the MBMS service start indication to the source base station (S720). The MBMS service start indication indicates whether the target base station supports the MBMS and in particular, indicates that the target base station supports the MBMS through the MRB. Table 2 is one example of the MBMS service start indication.

TABLE 2

| MBMS type | TMGI | MRB on/off |
|---|---|---|
| MBMS 1 | A | off |
| MBMS 2 | B | on |
| MBMS 3 | C | off |

The source base station transmits the MBMS service response indication to the user equipment (S725). The user equipment may find whether to receive the MBMS from the target base station by using information included in the MBMS service response indication, information on the cell, the CC, or the frequency in which the MBMS is provided, and whether the MBMS is provided from the target base station through the dedicated bearer or the MRB.

The target base station transmits the same MBMS which the user equipment receives from the source base station to the user equipment (S730). The user equipment may receive the MBMS from the target base station by using the MBMS information in a specific cell or at a specific frequency in the target base station for each MBMS.

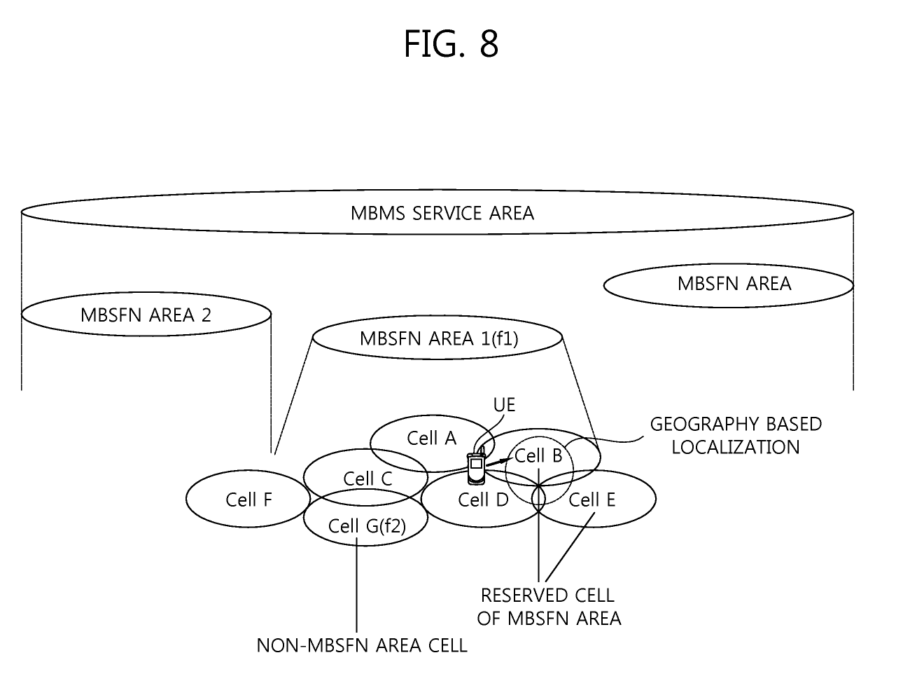

FIG. 8 is another example of a general scenario applied with the handover method for service continuity in the MBMS according to the present invention. In this scenario, the handover method of FIG. 7 may be applied. FIG. 7 illustrates a case in which the user equipment UE moves to the reserved cell in the MBSFN area.

Referring to FIG. 8, the user equipment UE is positioned in the cell D and receives the MBMS through the MRB. The cell B is a cell that may transmit the MBMS through f1, but a reserved cell that does not provide the current MBMS. Since the user equipment may use the same f1 in the same MBSFN at the time of moving from the cell D to the cell B, the user equipment continuously decodes the MBSFN subframe configured in order to continuously receive the MBMS. However, since the cell B is the reserved cell, the MBMS is not supported at present and the MBSFN subframe is continuously decoded to cause power loss of the user equipment. In the case of FIG. 7, the handover method for the continuity of the MBMS in which the cell D is the serving cell and the cell B is the target cell may be applied.

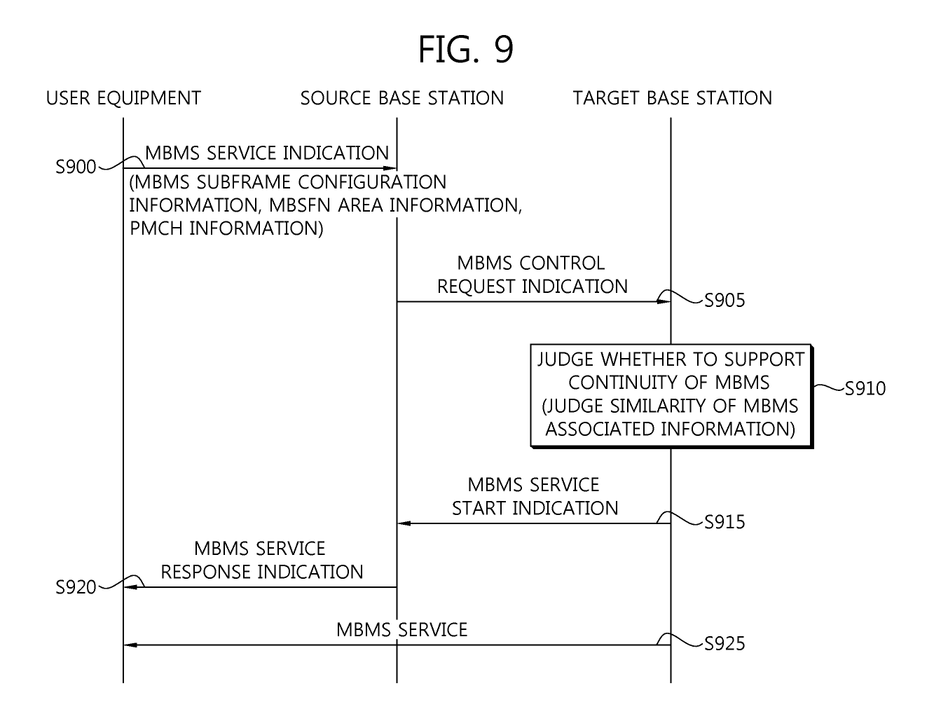

FIG. 9 is a flowchart describing a handover method for service continuity in an MBMS according to yet another exemplary embodiment of the present invention. In this case, the target base station is present in the MBSFN area different from the source base station.

Referring to FIG. 9, the user equipment transmits the MBMS service indication to the source base station (S900). Herein, the MBMS service indication includes the content of the MBMS service indication depending on step S500 of FIG. 5. Additionally, the MBMS service indication may include at least one of MBMS subframe configuration information, MBSFN area information, and PMCH information. The MBMS subframe configuration information defines subframes reserved for the MBSFN in the downlink. Table 3 shows one example of the MBMS subframe configuration information.

TABLE 3
-- ASN1START
MBSFN-SubframeConfig ::=SEQUENCE {
radioframeAllocationPeriodENUMERATED {n1, n2, n4, n8, n16, n32},
radioframeAllocationOffsetINTEGER (0..7),
subframeAllocationCHOICE {
oneFrameBIT STRING (SIZE(6)),
fourFramesBIT STRING (SIZE(24))
}
}
-- ASN1STOP

Referring to Table 3, a radio frame allocation period and a radio frame allocation offset are used to calculate radio frames including the MBSFN subframes. For example, radio frames including subframe numbers (SFN) are generated, which meet SFN mod radioFrameAllocationPeriod=radioFrameAllocationOffset. Values for the radio frame allocation period, n1 and n2 represent 1 and 2, respectively. When a fourframe configuration is used for subframeAllocation, n1 and n2 are not applied.

The subframeAllocation defines subframes allocated for the MBSFN within radioFrameAllocationPeriod and radioFrameAllocationOffset.

In a oneFrame configuration, 1 indicates that the corresponding radio frame is allocated for the MBSFN. A mapping relationship below may be established in FDD and TDD. First, in FDD, a 1^{st} or leftmost bit of a oneFrame configuration field defines MBSFN allocation for subframe 1, a 2^{nd} bit defines MBSFN allocation for subframe 2, a 3^{rd} bit defines subframe 3, a 4^{th} bit defines MBSFN allocation for subframe 6, a 5^{th} bit defines MBSFN allocation for subframe 7, and a 6^{th} bit defines MBSFN allocation for subframe 8. Next, in HDD, a 1^{st} or leftmost bit defines MBSFN allocation for subframe 3, a 2^{nd} bit defines MBSFN allocation for subframe 4, a 3^{rd} bit defines subframe 7, a 4^{th} bit defines MBSFN allocation for subframe 8, and a 5^{th} bit defines MBSFN allocation for subframe 9. Uplink subframes are not allocated and the last bit is not used.

In the fourFrame configuration, 1 indicates that the corresponding subframe is allocated for the MBSFN according to a bitmap of the fourFrame configuration field indicating the MBSFN subframe allocation within four consecutive radio frames. The bitmap may be analyzed as below. First, in FDD, respective allocations of a 1^{st} radio frame, and a 1^{st} or leftmost bit are first applied to subframes 1, 2, 3, 4, 6, 7, and 9 according to a sequence of four radio frames. Next, in TDD, respective allocations of a 1^{st} radio frame, and a 1^{st} or leftmost bit are first applied to subframes 3, 4, 7, 8, and 9 according to the sequence of four radio frames. Last four bits are not used and the uplink subframe is not allocated.

The MBSFN area information as a list of a plurality of fields includes information required to obtain MBMS control information associated with one or more MBSFN areas. Table 4 shows one example of the MBSFN area information.

TABLE 4
-- ASN1START
MBSFN-AreaInfoList ::=SEQUENCE (SIZE(1..maxMBSFN-Area))
OF MBSFN-AreaInfo
MBSFN-AreaInfo ::=SEQUENCE {
mbsfn-AreaIdINTEGER (0..255),
non-MBSFNregionLengthENUMERATED {s1, s2},
notificationIndicationINTEGER (0..7),
mcch-ConfigSEQUENCE {
mcch-RepetitionPeriodENUMERATED {rf32, rf64, rf128, rf256},
mcch-OffsetINTEGER (0..10),
mcch-ModificationPeriodENUMERATED {rf512, rf1024},
sf-AllocInfoBIT STRING (SIZE(6)),
signallingMCSENUMERATED {n2, n7, n13, n19}
},
...
}
-- ASN1STOP

Each field in the MBSFN area information will be described in Table 5.

TABLE 5

| Field | Description |
|---|---|
| mbsfn-AreaId | indicates ID (N_{ID}^{MBSFN}) of the MBSFN area. |
| signallingMCS | indicates the MCS applied to the subframe indicated by the sf- |
| | AllocInfo field and the first subframe of each MCH scheduling. |
| nonMBSFNregionLength | indicates the number of symbols constituting the non-MBSFN area |
| | from the start of the subframe. This value is applied to all of the |
| | subframes in the MBSFN area used for the PMCH transmission as |
| | indicated by the MSI. |
| notificationIndication | indicates the PDCCH bit used to notify the change of the MCCH |
| | which may be applied to the current MBSFN area to the user |
| | equipment. |
| mcch- | defines the transmission interval of the MCCH information. The |
| RepetitionPeriod | transmission interval is defined by the unit of the radio frame. |
| mcch-Offset | indicates the radio frame in which the MCCH is scheduled together |
| | with mcch-RepetitionPeriod. |
| mcch- | defines boundaries which appear periodically. The boundaries are |
| ModificationPeriod | expressed by the radio frame unit and are radio frames in which SFN |
| | mod mcch-ModificationPeriod = 0. Contents of different MCCH |
| | information transmission may be different if at least boundary is |
| | present between the transmissions. |
| sf-AllocInfo | indicates subframes that transport the MCCH in the radio frame |
| | indicated by mcch-RepetitionPeriod and mcch-Offset. |

Referring to Table 5, a value of signalingMCS, n2 means MCS level 2. Values of non-MBSFNregionLength, s1 and s2 correspond to one symbol and two symbols, respectively. A value of notificationIndication, 0 corresponds to a least significant bit (LSB). Values of mcch-RepetitionPeriod, rf32 and rf64 correspond to 32 radio frames and 64 radio frames, respectively. A value of sf-AllocInfo, 1 indicates that the corresponding subframe is allocated. The following mapping relationship may be established in the subframe allocation information. First, in FDD, a 1^{st} or leftmost bit defines MBSFN allocation for subframe 1 in the radio frame indicated by mcch-RepetitionPeriod and mcch-Offset, a 2^{nd} bit defines MBSFN allocation for subframe 2, a 3^{rd} bit defines MBSFN allocation for subframe 3, a 4^{th} bit defines MBSFN allocation for subframe 6, a 5^{th} bit defines MBSFN allocation for subframe 7, and a 6-th bit defines MBSFN allocation for subframe 8. Next, in TDD, a 1^{st} or leftmost bit defines MBSFN allocation for subframe 3 in the radio frame indicated by mcch-RepetitionPeriod and mcch-Offset, a 2^{nd} bit defines MBSFN allocation for subframe 4, a 3^{rd} bit defines subframe 7, a 4^{th} bit defines MBSFN allocation for subframe 8, and a 5^{th} bit defines MBSFN allocation for subframe 9. Uplink subframes are not allocated and the last bit is not used.

PMCH information as a list of a plurality of fields specifies configurations of all PMCHs in the MBSFN area. The PMCH information provided for the individual PMCHs include configuration parameters for sessions transported by the corresponding PMCH. Table 6 shows one example of the PMCH information.

TABLE 6
-- ASN1START
PMCH-InfoList ::=SEQUENCE (SIZE (0..maxPMCH-PerMBSFN))
OF PMCH-Info
PMCH-Info ::=SEQUENCE {
pmch-ConfigPMCH-Config,
mbms-SessionInfoListMBMS-SessionInfoList,
...
}
MBMS-SessionInfoList ::=SEQUENCE (SIZE (0..maxSessionPerPMCH))
OF MBMS-SessionInfo
MBMS-SessionInfo ::=SEQUENCE {
tmgiTMGI,
sessionIdOCTET STRING (SIZE (1)) OPTIONAL, -- Need OR
logicalChannelIdentityINTEGER (0..maxSessionPerPMCH−1),
...
}
PMCH-Config ::=SEQUENCE {
sf-AllocEndINTEGER (0..1535),
dataMCSINTEGER (0..28),
mch-SchedulingPeriodENUMERATED {
rf8, rf16, rf32, rf64, rf128, rf256, rf512, rf1024},
...
}
TMGI ::=SEQUENCE {
plmn-IdCHOICE {
plmn-IndexINTEGER (1..6),
explicitValuePLMN-Identity
},
serviceIdOCTET STRING (SIZE (3))
}
-- ASN1STOP

Each field included in the PMCH information according to Table 6 will be described in Table 7.

TABLE 7

| Field | Description |
|---|---|
| sessionID | indicates an additional MBMS session identifier. The |
| | sessionID field is included in the PMCH information |
| | whenever the upper hierarchy allocates the session |
| | identifier. |
| sf-AllocEnd | indicates the last subframe allocated to the (P)MCH |
| | within a period identified by the commonSF- |
| | AllocPeriod. |
| mch- | indicates the MCH scheduling period. may be, for |
| SchedulingPeriod | example, a period used to provide the MCH scheduling |
| | information in the lower hierarchy such as the MAC |
| | hierarchy. |
| dataMCS | indicates a value of the MCS applied to the subframes |
| | of the current (P)MCH. |
| plmn-Index | indicates an index of an entry of the plmn-IdentityList |
| | field in the system information block (SIB) of type 1. |
| sessionId | indicates an identifier for a session of the MBMS. |
| serviceId | is an identifier that uniquely indicates the MBMS in |
| | the PLMN. The service ID field includes 3 or 5 octets |
| | of the TMGI. A first octet includes a third octet of |
| | the TMGI and a second octet includes a fourth octet |
| | of the TMGI. |

Referring to Table 7, values of mch-SchedulingPeriod, rf8 and rf16 mean 8 radio frames and 16 radio frames, respectively.

Referring back to FIG. 9, the source base station transmits the MBMS control request indication to the target base station (S905). Herein, the MBMS control request indication includes the content of the MBMS control request indication described in step S505 of FIG. 5. Additionally, the MBMS service indication may include at least one of the aforementioned MBMS subframe configuration information, MBSFN area information, and PMCH information.

The target base station judges whether to support the continuity of the MBMS for the user equipment based on the MBMS control request indication (S910). Herein, a method of judging whether to support the continuity of the MBMS includes the judgment method in step S510 of FIG. 5. Additionally, judging whether to support the continuity of the MBMS includes judging similarity of MBMS associated information of the current source base station and target base station based on the MBMS subframe configuration information, the MBSFN area information, and the PMCH information in the MBMS service indication which the target base station receives from the source base station. The MBSFN between the source base station and the target base station is changed, but the MBMS subframe configuration information, the MBSFN area information, and the PMCH information may be all the same as each other and only some information may be different from each other.

Therefore, hen the MBMS associated information between the source base station and the target base station is the same, the target base station may notify that the user equipment may receive the MBMS through the MRB from even the target base station, to the user equipment. When the MBMS associated information between the source base station and the target base station is not the same, the target base station may notify to the user equipment that the user equipment may not receive the MBMS from the target base station through the MRB. Since the information which is not the same is information to be changed by the target base station, the corresponding information may be transmitted from the target to the source base station with being included in the MBMS service start indication.

Additionally, judging whether to support the continuity of the MBMS includes judging whether to provide the MBMS through the dedicated bearer or the MRB. The target base station may configure not the dedicated bearer but the MRB and provide the MBMS by using the MBSFN subframe when the number of the user equipments that receive the MBMS is equal to or more than a specific threshold. For example, it is assumed that the specific threshold is 10 (UEs). When the number of user equipments is 10 with the movement of the user equipments, it is preferable in terms of the radio efficiency that the target base station provides the MBMS by using the MRB rather than the dedicated bearer. Therefore, the target base station may configure the MRB for the MBMS.

The target base station transmits the MBMS service start indication to the source base station (S915). The MBMS service start indication indicates whether the target base station supports the MBMS and in particular, indicates that the target base station supports the MBMS through the MRB. Herein, the MBMS service indication includes a content of the MBMS service start indication depending on step S720 of FIG. 7. Additionally, since the MBS associated information which is not the same between the target base station and the source station is information to be changed by the target base station, the corresponding information may be transmitted from the target to the source base station with being included in the MBMS service start indication.

The source base station transmits the MBMS service response indication to the user equipment (S920). The user equipment may find whether to receive the MBMS from the target base station by using information included in the MBMS service response indication, information on the cell, the CC, or the frequency in which the MBMS is provided, and whether the MBMS is provided from the target base station through the dedicated bearer or the MRB.

The target base station transmits the same MBMS which the user equipment receives from the source base station to the user equipment (S925). The user equipment may receive the MBMS from the target base station by using the MBMS information in a specific cell or at a specific frequency in the target base station for each MBMS.

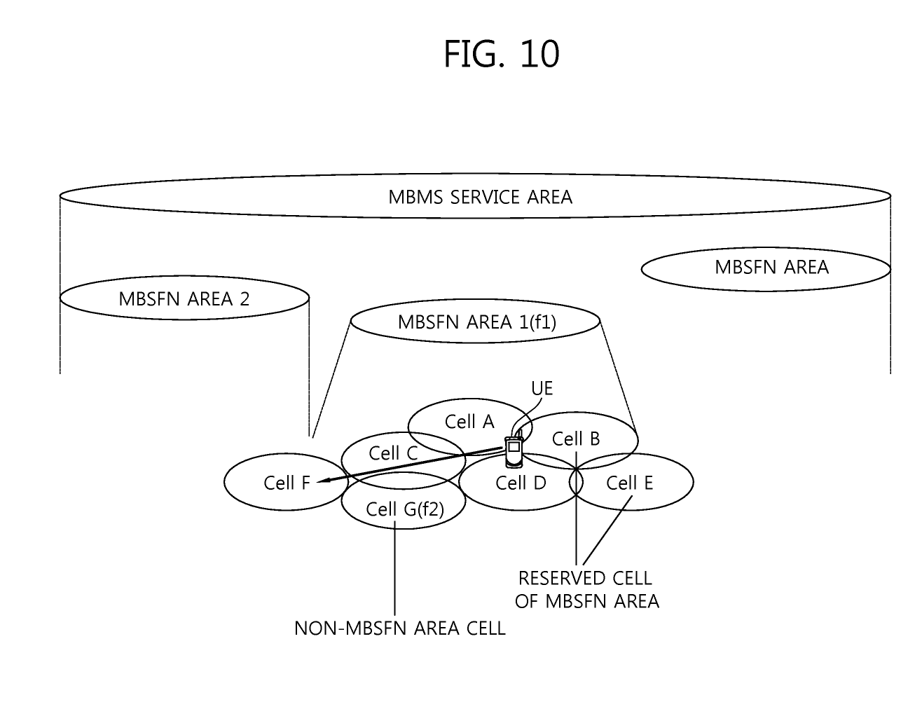

FIG. 10 is yet another example of the general scenario applied with the handover method for service continuity in the MBMS according to the present invention. In this scenario, the handover method of FIG. 9 may be applied. FIG. 10 illustrates a case in which the user equipment UE moves to another MBSFN area.

Referring to FIG. 10, the user equipment is positioned in the cell D of the MBSFN area 1 and receives the MBMS through the MRB, and the user equipment moves to the cell F of the MBSFN area 2. In this case, two cases are enabled. First, the same MBMS may be provided at the same frequency band in the area to which the user equipment moves. Second, the same MBMS may be provided at difference frequency bands in the area to which the user equipment moves.

In the first case, the MBMS is provided through fl in the MBSFN area 1 and the MBMS is provided through f1 even in the MBSFN area 2. Even though the MBSFN area is changed, the MRB frequency for the MBMS is actually the same, and as a result, the MBMS may be continuously supported. Therefore, the handover method for the service continuity in the MBMS of FIG. 9 may be applied to the scenario of FIG. 10 and in this case, the source cell is the cell D and the target cell is the cell F.

In the second case, the MBMS is provided through f1 in the MBSFN area 1 and the MBMS is provided through f3 in the MBSFN area 2. Therefore, the user equipment may not automatically receive the MBMS of the MBSFN area 2 in a mode set in the MBSFN area 1. In this case, when the MBSFN is changed and the frequency for the MBMS is changed, it may be determined that the continuity of the MBMS is not provided. The reason for judging that the continuity of the MBMS is not provided is that the user equipment may receive the corresponding MBMS at f2 in the MBSFN area 2 only after receiving a new MBMS associated configuration and applying the received configuration in order to receive the corresponding MBMS provided in the MBSFN area 2 at f2 while the MBMS provided in the MBSFN area 1 is provided at f1. However, in some cases, even when the frequencies for the MBMS supported in the MBSFN area 1 and the MBMS service area 2 are different as f1, f2, and the like, the MBMS may be received in the mode illustrated in FIG. 9, in order to more efficiently support the MBMS.

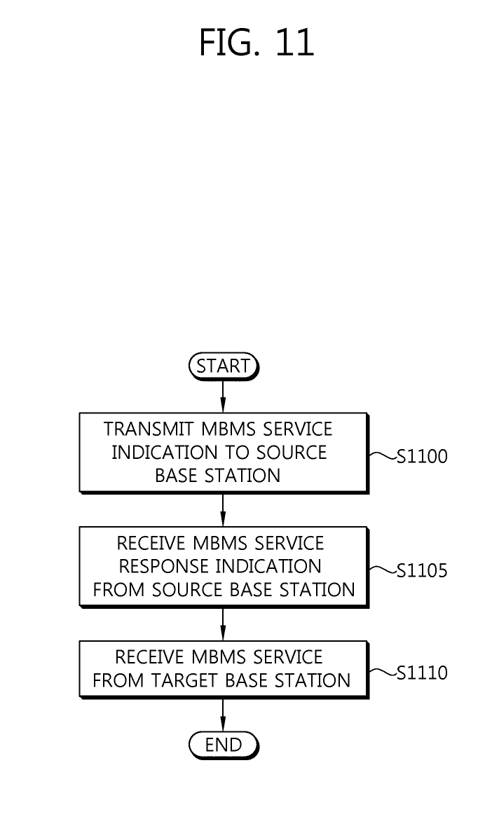

FIG. 11 is a flowchart describing a handover method for service continuity in an MBMS, which is performed by a user equipment according to an exemplary embodiment of the present invention.

Referring to FIG. 11, the user equipment transmits the MBMS service indication to the source base station (S1100). As one example, the MBMS service indication is an indication that notifies whether the user equipment receives the MBMS through the MRB. For example, a form of the MBMS service indication is a flag and the MBMS service indication may indicate 0 or 1. When the MBMS service indication is 1, the user equipment receives the MBMS and when the MBMS service indication is 0, the user equipment does not receive the MBMS. Herein, even though the user equipment receives at least one MBMS among a plurality of MBMSs, the MBSM indication may be set to 1.

As another example, the MBMS service indication may be an indication that indicates a type of the MBMS received by the user equipment. The reason is that the user equipment may simultaneously receive a plurality of MBMSs, MBMS service areas or MBSFN areas for the respective MBMSs may be different from each other, and the MBMS which is performed at a location at which the current user equipment receives the MBMS needs to be notified. The type of the MBMS may be distinguished by a temporary mobile group identity (TMGI) for the MBMS.

For example, the MBMS service indication may be configured in a list form like TMGI A, B, and C when the plurality of MBMS user equipments receives MBMSs A, B, and C. Alternatively, one MBMS service indication may indicate a type of one MBMS. That, the MBMS type may be individually configured and transmitted by the MBMS service indication. For example, it may be configured in such a manner that MBMS service indication 1=TMGI A, MBMS service indication 2=TMGI B, and MBMS service indication 3=TMGI C.

As yet another example, the MBMS service indication may indicate the MBMS type and whether to receive the MBMS. That is, the MBMS service indication indicates all types of MBMSs as well as indicating whether to receive the MBMS as the flag.

As another example, the MBMS indicator may include MBMS interest information indicating whether the user equipment prefers receiving the MBMS. If the MBMS interest information indicates the interest in receiving the MBMS, the target base station may find that the user equipment takes an interest in receiving the MBMS. The MBMS interest information may be configured in a flag form. For example, when the MBMS interest information is 1, it is indicated that the user equipment takes an interest in receiving the MBMS and when the MBMS interest information is 0, it is indicated that the user equipment does not take an interest in receiving the MBMS. When it is judged that the user equipment takes an interest in receiving the MBMS, the target base station may perform the MBMS and when there is an MBMS desired by the user equipment, the user equipment may receive the MBMS through the MRB. Alternatively, when the MBMS may be received by the MRB and a dedicated radio bearer, the MBMS needs to be received through the MRB.

The MBMS service indication may be included in a measurement reporting message in the handover procedure. Alternatively, the MBMS service indication may be included in a separate message associated with the handover procedure.

Additionally, the MBMS service indication may include at least one of the MBMS subframe configuration information according to Table 3, the MBSFN area information according to Table 4, and the PMCH information according to Table 6.

The user equipment receives the MBMS service response indication from the source base station (S 1105). The MBMS service response indication may be included in a handover command message or be a separate independent message. The user equipment may obtain information regarding whether the user equipment is enabled or disabled to receive the MBMS from the target base station by using information included in the MBMS service response indication, and the cell, CC, or frequency in which the MBMS is provided.

The user equipment receives the same MBMS received from the source base station from the target base station (S1110). The user equipment may receive the MBMS from the target base station by using the MBMS information in a specific cell or at a specific frequency in the target base station for each MBMS.

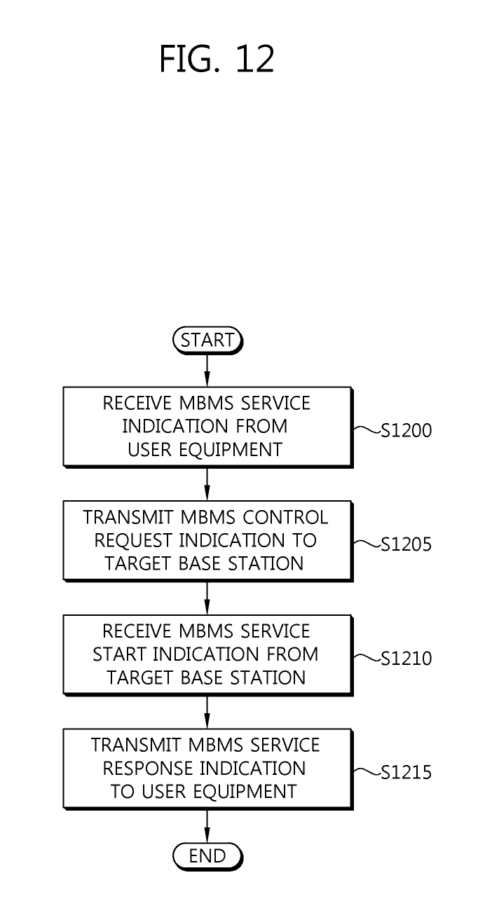

FIG. 12 is a flowchart describing a handover method for service continuity in an MBMS, which is performed by a source base station according to an exemplary embodiment of the present invention.

Referring to FIG. 12, the source base station receives the MBMS service indication from the user equipment (S1200). The MBMS service indication includes the MBMS service indication in step S1100 of FIG. 11.

The source base station transmits the MBMS control request indication to the target base station (S1205). The MBMS control request indication is information in which the source base station requests controlling the MBMS to the target base station in order to assure MBMS continuity of the user equipment and may include the same form or the same information as the MBMS service indication. For example, the MBMS control request indication may indicate whether the user equipment receives the MBMS. Alternatively, the MBMS control request indication may indicate the type of the MBMS received by the user equipment. The MBMS control request indication may be information defined in the X2 interface. The MBMS control request indication may be included in a handover request message or one independent message which is apart from the handover request message.

The MBMS control request indication may include at least one of the MBMS subframe configuration information according to Table 3, the MBSFN area information according to Table 4, and the PMCH information according to Table 6.

Alternatively, the MBMS control request indication may include the MBMS interest information indicating whether the user equipment take an interest in receiving the MBMS. If the MBMS interest information indicates the interest in receiving the MBMS, the target base station may find that the user equipment takes an interest in receiving the MBMS. The MBMS interest information may be configured in a flag form. For example, when the MBMS interest information is 1, it is indicated that the user equipment takes an interest in receiving the MBMS and when the MBMS interest information is 0, it is indicated that the user equipment does not take an interest in receiving the MBMS. When it is judged that the user equipment takes an interest in receiving the MBMS, the target base station may perform the MBMS and when there is an MBMS desired by the user equipment, the user equipment may receive the MBMS through the MRB. Alternatively, when the MBMS may be received by the MRB and a dedicated radio bearer, the MBMS needs to be received through the MRB.

The source base station transmits the MBMS service start indication from the target base station (S1210). The MBMS service start indication indicates whether the target base station supports the MBMS. Herein, the MBMS may include a service supported through the RB in addition to the service supported through the MRB. The MBMS service start indication may be transmitted with being included in a handover request response message or transmitted with being included in a separate independent message therefrom.

As one example, the MBMS service start indication may indicate only whether to support the MBMS. For example, the target base station judges whether to support the continuity of the MBMS and when it is judged that the user equipment uses the MBMS, the target base station sets the MBMS service start indication to 1. This indicates that the target base station may continuously support the MBMS for the user equipment. That is, this means that the user equipment may receive the MBMS in the serving cell similarly to the MRB. On the contrary, the target base station judges whether to support the continuity of the MBMS and when it is judged that the user equipment does not use the MBMS, the target base station sets the MBMS service start indication to 0. This means that the target base station may not continuously support the MBMS for the user equipment.

As another example, the MBMS service start indication may include information on a cell, a CC, or a frequency to be used to provide the MBMS to the user equipment.

As yet another example, the MBMS service start indication may include information regarding the type for the MBMS received by the user equipment and a cell, a CC, or a frequency which the target base station may support for each MBMS as described in Table 8.

TABLE 8

| MBMS type | TMGI | enable/disable | Frequency |
|---|---|---|---|
| MBMS 1 | A | enable | CC1 |
| MBMS 2 | B | disable | CC2 |
| MBMS 3 | C | enable | CC3 |

Referring to Table 82, the MBMS service start indication includes the TMGI to identify each MBMS, and information regarding whether the target base station is enabled or disabled to support the corresponding MBMS and frequency bands (CC1, CC2, CC3, and the like).

The source base station transmits the MBMS service response indication to the user equipment (S1215). The MBMS service response indication may be included in a handover command message or be a separate independent message. The user equipment may obtain information regarding whether the user equipment is enabled or disabled to receive the MBMS from the target base station by using information included in the MBMS service response indication, and the cell, CC, or frequency in which the MBMS is provided.

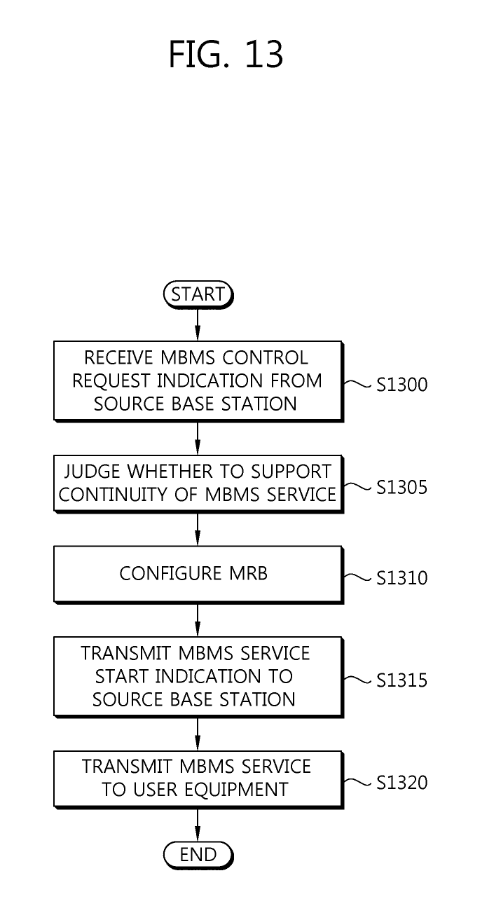

FIG. 13 is a flowchart describing a handover method for service continuity in an MBMS, which is performed by a target base station according to an exemplary embodiment of the present invention.

Referring to FIG. 13, the target base station receives a MBMS control request indication from a source base station (S1300).

The target base station judges whether to support the service continuity of the MBMS for the user equipment based on the MBMS control request indication (S1305). Herein, the judging whether to support the service continuity of the MBMS includes judging on whether the user equipment is a user equipment that receives the MBMS. When the user equipment is a user equipment that receives the MBMS, the target base station determines supporting the service continuity of the MBMS of the user equipment. On the contrary, when the user equipment is not a user equipment that does not receive the MBMS, the target base station does not determine supporting for the service continuity of the MBMS of the user equipment.

Alternatively, the judging on whether to support the service continuity of the MBMS includes judging whether providing the MBMS itself is possible or impossible.

Alternatively, when the target base station is changed, judging whether to support the service continuity of the MBMS includes judging what cell, component carrier, or frequency the target base station provides each MBMS through. The reason is that a specific MBMS may be supported by only a specific cell, component carrier, or frequency.

Alternatively, the judging on whether to support the service continuity of the MBMS includes judging a type of MBMS received by the user equipment. The reason is that there may be present an MBMS which the target cell or the target base station is capable of supporting or there may be present an MBMS which the target cell or the target base station is incapable of supporting.

Additionally, the judging on whether to support the service continuity of the MBMS includes judging similarity of MBMS associated information of current source base station and target base station based on MBMS subframe configuration information, MBSFN area information, and PMCH information in the MBMS service indication which the target base station receives from the source base station. The MBSFN between the source base station and the target base station is changed, but the MBMS subframe configuration information, the MBSFN area information, and the PMCH information may be all the same as each other, and only some information may be different from each other.

Therefore, when the MBMS associated information between the source base station and the target base station is the same as each other, the target base station may notify that the user equipment may receive the MBMS through the MRB from even the target base station, to the user equipment. When the MBMS associated information between the source base station and the target base station is not the same as each other, the target base station may notify to the user equipment that the user equipment may not receive the MBMS from the target base station through the MRB in a target cell. Since the information which is not the same is information to be changed by the target base station, the corresponding information may be transmitted from the target to the source base station with being included in the MBMS service start indication.

Additionally, the judging on whether to support the service continuity of the MBMS includes judging whether to provide the MBMS as the dedicated bearer or the MRB. The target base station may set not the dedicated bearer but the MRB, and provide the MBMS by using the MBSFN subframe, when the number of user equipments that receive the MBMS in the target cell is equal to or more than a specific threshold. For example, it is assumed that the specific threshold is 10 (UEs). When the number of user equipments is 10 with the movement of the user equipments, it is preferable in terms of radio efficiency that the target base station provides the MBMS by using the MRB rather than the dedicated bearer. Therefore, the target base station may set the MRB for the MBMS (S1310).

The target base station transmits the MBMS service start indication to the source base station (S1315). The MBMS service start indication indicates whether the target base station supports the MBMS. Herein, the MBMS may include a service supported through the RB in addition to the service supported through the MRB. The MBMS service start indication may be transmitted with being included in a handover request response message or transmitted with being included in a separate independent message therefrom.

The target base station transmits the same MBMS which the user equipment receives from the source base station, to the user equipment (S1320). As a result, the user equipment may receive the MBMS from the target base station by using the MBMS information which is supportable in a specific cell or at a specific frequency in the target base station for each MBMS.

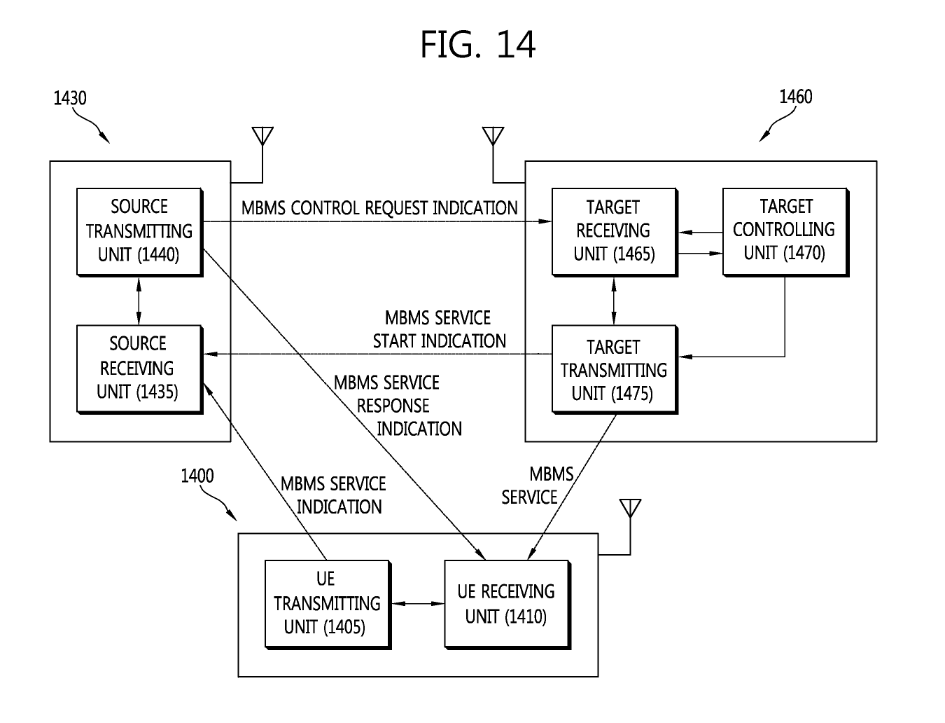

FIG. 14 is a block diagram illustrating a user equipment, a source base station, and a target base station that perform a handover method for service continuity in an MBMS according to an exemplary embodiment of the present invention.

Referring to FIG. 14, a user equipment 1400 includes a user equipment transmitting unit 1405 and a service receiving unit 1410.

The user equipment transmitting unit 1405 generates MBMS service indication to transmit the generated MBMS service indication to a source base station 1430. As one example, the MBMS service indication is an indication that notifies whether the user equipment 1400 receives the MBMS through the MRB. For example, a form of the MBMS service indication is a flag, and the MBMS service indication may indicate 0 or 1. When the MBMS service indication is 1, the user equipment 1400 is a user equipment which receives the MBMS, and when the MBMS service indication is 0, the user equipment is a user equipment which does not receive the MBMS. Herein, even though the user equipment receives only at least one of a plurality of MBMSs, the MBSM indication may be set to 1.

The MBMS service indication may include MBMS interest information indicating whether the user equipment 1400 takes an interest in receiving the MBMS. If the MBMS interest information indicates the interest in receiving the MBMS, a target controller 1470 may verify that the user equipment 1400 takes an interest in receiving the MBMS. The MBMS interest information may be configured in a flag form. For example, when the MBMS interest information is 1, it is indicated that the user equipment 1400 takes an interest in receiving the MBMS, and when the MBMS interest information is 0, it is indicated that the user equipment 1400 does not take an interest in receiving the MBMS. When it is judged that the user equipment takes an interest in receiving the MBMS, the target controller 1470 may perform the MBMS, and when there is an MBMS desired by the user equipment 1400, the user equipment 1400 may receive the MBMS through the MRB. Alternatively, when the MBMS may be received through the MRB and the dedicated radio bearer, the target controller 1470 performs a scheduling so that the user equipment 1400 may receive the MBMS through the MRB.

As another example, the MBMS service indication may be an indication that indicates a type of MBMS received by the user equipment 1400. The reason is that the user equipment 1400 may simultaneously receive a plurality of MBMSs, MBMS service areas or MBSFN areas for the respective MBMSs may be different from each other, and whether the MBMS which is performed at a location at which the current user equipment 1400 receives the MBMS needs to be notified. The type of MBMS may be distinguished by a temporary mobile group identity (TMGI) for the MBMS.

For example, the MBMS service indication may be configured in a list form like TMGI A, B, and C, while the plurality of MBMS user equipments receives MBMSs A, B, and C. Alternatively, one MBMS service indication may indicate a type of MBMS. That is, the MBMS type may be individually configured and transmitted by the MBMS service indication. For example, it may be configured in such a manner that MBMS service indication 1=TMGI A, MBMS service indication 2=TMGI B, and MBMS service indication 3=TMGI C.

Alternatively, the MBMS service indication may include information regarding the MBMS type and MBMS interest information indicating whether the user equipment takes an interest in receiving each type of MBMS. For example, the MBMS service indication may represent whether the user equipment takes an interest receiving the MBMS for each MBMS type as the flag in such a manner of {MBMS type=TMGI A, MBMS interest information=1}, {MBMS type=TMGI B, MBMS interest information=0}, and {MBMS type=TMGI C and MBMS interest information=1}. Herein, in the MBMSs A and C, since the MBMS interest information is 1, the target controller 1470 needs to preferentially set the MBMS to the MRB after the handover. On the contrary, in the case of the MBMS B, the target controller 1470 may set the MBMS to the MRB at a lower priority than other A and C.

As yet another example, the MBMS service indication may indicate the MBMS type and whether to receive the MBMS. That is, the MBMS service indication indicates all types of MBMSs as well as indicating whether to receive the MBMS as the flag.

Additionally, the MBMS service indication may include at least one of MBMS subframe configuration information according to Table 3, MBSFN area information according to Table 4, and PMCH information according to Table 6.

The MBMS service indication may be included in a measurement report message in the handover procedure. Alternatively, the MBMS service indication may be included in a separate message irrelevant to the handover procedure.

The user equipment receiving unit 1410 receives MBMS service response indication from the source base station 1430. The MBMS service response indication may be included in a handover command message, or be a separate independent message. The user equipment 1400 may obtain information regarding whether the user equipment is enabled or disabled to receive the MBMS from the target base station by using information included in the MBMS service response indication, and information regarding a cell, a CC, or a frequency in which the MBMS is provided.

Meanwhile, the user equipment receiving unit 1410 receives the same MBMS received from the source base station 1430, from the target base station 1460 even after the handover. As a result, the user equipment 1400 may receive the MBMS from the target base station 1460 by using the MBMS information which is supportable in a specific cell or at a specific frequency in the target base station 1460 for each MBMS.

The source base station 1430 includes a source receiving unit 1435 and a source transmitting unit 1440. The source receiving unit 1435 receives the MBMS service indication from the user equipment 1400. Further, the source receiving unit 1435 receives the MBMS service indication from the target base station 1460. The MBMS service start indication indicates whether the target base station 1460 supports the MBMS. Herein, the MBMS may include a service supported through the RB in addition to the service supported through the MRB. The MBMS service start indication may be transmitted with being included in a handover request response message, or transmitted with being included in a separate independent message therefrom.

As one example, the MBMS service start indication may indicate only whether to support the MBMS. For example, the target base station 1460 judges whether to support the service continuity of the MBMS, and thereafter, when it is judged that the user equipment 1400 uses the MBMS, the target base station 1460 sets the MBMS service start indication to 1. This indicates that the target base station 1460 may continuously support the MBMS for the user equipment 1400. That is, this means that the user equipment 1400 may receive the MBMS in the source base station 1430, similarly to the MRB. On the contrary, the target base station 1460 judges whether to support the service continuity of the MBMS, and thereafter, when it is judged that the user equipment does not use the MBMS, the target base station 1460 sets the MBMS service start indication to 0. This means that the target base station 1460 may not continuously support the MBMS for the user equipment 1400.

As another example, the MBMS service start indication may include information on a cell, a CC, or a frequency to be used to provide the MBMS to the user equipment 1400.

As yet another example, the MBMS service start indication may include information regarding a type of MBMS received by the user equipment 1400, and a cell, a CC, or a frequency which the target base station 1460 may support for each MBMS as described in Table 8.

Additionally, the MBMS service start indication may include at least one of MBMS subframe configuration information according to Table 3, MBSFN area information according to Table 4, and PMCH information according to Table 6.

The source transmitting unit 1440 transmits the MBMS control request indication to the target base station 1460. The MBMS control request indication is information in which the source base station 1430 requests the MBMS control to the target base station 1460 in order to assure the service continuity of the MBMS of the user equipment 1400, and may include the same form or the same information as the MBMS service indication. For example, the MBMS control request indication may indicate whether the user equipment 1400 receives the MBMS. Alternatively, the MBMS control request indication may indicate a type of MBMS received by the user equipment 1400. The MBMS control request indication may be information defined in the X2 interface. The MBMS control request indication may be included in a handover request message, or one independent message which is apart from the handover request message.

Further, the source transmitting unit 1440 transmits the MBMS service response indication to the user equipment 1400. The MBMS service response indication may be included in a handover command message, or be a separate independent message. The user equipment 1400 may obtain whether the user equipment 1400 is enabled or disabled to receive the MBMS from the target base station 1460 by using information included in the MBMS service response indication, and information regarding a cell, a CC, or a frequency in which the MBMS is provided.

The target base station 1460 includes a target receiving unit 1465, a target controller 1470, and a target transmitting unit 1475.

The target receiving unit 1465 receives MBMS control request indication from the source base station 1430.

The target controller 1470 judges whether to support the service continuity of the MBMS for the user equipment 1400 based on the MBMS control request indication. Herein, the judging on whether to support the service continuity of the MBMS includes judging whether the user equipment 1400 is a user equipment that receives the MBMS. When the user equipment 1400 is the user equipment that receives the MBMS, the target controller 1470 determines supporting for the service continuity of the MBMS of the user equipment 1400. On the contrary, when the user equipment 1400 is not a user equipment that does not receive the MBMS, the target controller 1470 does not determine supporting for the service continuity of the MBMS of the user equipment.

Alternatively, the judging on whether to support the service continuity of the MBMS includes judging whether providing the MBMS itself is possible or impossible.

Alternatively, when the target base station 1460 is changed, the judging on whether to support the service continuity of the MBMS includes judging what cell, component carrier, or frequency the target base station 1460 provides each MBMS through. The reason is that a specific MBMS may be supported by only a specific cell, component carrier, or frequency.

Alternatively, the judging on whether to support the service continuity of the MBMS includes judging a type of MBMS received by the user equipment 1400. The reason is that there may be present an MBMS which the target base station 1460 is capable of supporting, or there may be present an MBMS which the target base station 1460 is incapable of supporting.

Additionally, the judging on whether to support the service continuity of the MBMS includes judging similarity of MBMS associated information of the current source base station 1430 and target base station 1460 based on the MBMS subframe configuration information, the MBSFN area information, and the PMCH information in the MBMS service indication which the target base station 1460 receives from the source base station 1430. The MBSFN area between the source base station 1430 and the target base station 1460 is changed, but the MBMS subframe configuration information, the MBSFN area information, and the PMCH information may be all the same as each other, and only some information may be different from each other.

Accordingly, when it is judged that the MBMS associated information is the same between the source base station 1430 and the target base station 1460, the target controller 1470 may notify that the user equipment 1400 may receive the MBMS through the MRB even in the target base station 1460, to the user equipment 1400. When the MBMS associated information is not the same between the source base station 1430 and the target base station 1460, the target controller 1470 may notify that the user equipment 1400 may not receive the MBMS through the MRB in the target base station 1460, to the user equipment 1400. Since the information which is not the same is information to be changed by the target base station 1460, the corresponding information may be transmitted from the target base station 1460 to the source base station 1430 with being included in the MBMS service start indication.

Additionally, the judging on whether to support the service continuity of the MBMS includes judging whether to provide the MBMS through the dedicated bearer or the MRB. The target controller 1470 may set not the dedicated bearer but the MRB, and provide the MBMS by using the MBSFN subframe, when the number of user equipments that receive the MBMS in the target base station 1460 is equal to or more than a specific threshold. For example, it is assumed that the specific threshold is 10 (UEs). When the number of user equipments is 10 with the movement of the user equipments 1400, it is preferable in terms of radio efficiency that the target controller 1470 provides the MBMS by using the MRB rather than the dedicated bearer. Therefore, the target controller 1470 may set the MRB for the MBMS.

When the MBMS control request indication includes MBMS interest information, the target controller 1470 may verify whether the user equipment 1400 take an interest that the user equipment 1400 receives the MBMS according to indication of the MBMS interest information.

Further, when the MBMS interest information is 1 in the case where the user equipment 1400 does not receive the current MBMS through the MRB, the target controller 1470 needs to perform scheduling by taking a priority so that the user equipment 1400 receive the MBMS through the MRB.

The target transmitting unit 1475 transmits the MBMS service start indication to the source base station 1430. The MBMS service start indication indicates whether the target base station 1460 supports the MBMS. Herein, the MBMS may include a service supported through the RB in addition to the service supported through the MRB. The MBMS service start indication may be transmitted with being included in a handover request response message, or transmitted with being included in a separate independent message therefrom.

The target transmitting unit 1475 transmits the MBMS to the user equipment 1400 under the same condition when the user equipment 1400 receives the MBMS from the source base station 1430. As a result, the user equipment 1400 may receive the MBMS from the target base station 1460 by using the MBMS information which is supportable in a specific cell or at a specific frequency in the target base station 1460 for each MBMS.

All functions described above may be performed by processors such as a microprocessor, a controller, a micro-controller, an application specific integrated circuit (ASIC), and the like depending on software or a program code coded to perform the functions. Designing, developing, and implementing the code will be apparent to those skilled in the art based on the description of the present invention.

While the invention has been shown and described with respect to the preferred embodiments, it will be understood by those skilled in the art that various changes and modifications may be made without departing from the spirit and scope of the invention as defined in the following claims. Accordingly, the present invention is not limited the aforementioned embodiments and includes all embodiments within the scope of the appended claims.

1. A user equipment to receive a multimedia broadcast multicast service (MBMS), comprising:
a transmitting unit to transmit an MBMS service indication including at least one of configuration information representing a configuration of an MBMS subframe, which is a subframe in which the user equipment receives the MBMS in a radio frame, information regarding MBMS single frequency network (MBSFN) area, and information regarding a physical multicast channel (PMCH), which is a physical channel through which the MBMS is transmitted, to a source base station (source eNB) linked with the user equipment; and
a receiving unit to receive an MBMS service response indication indicating whether the MBMS is supported from a target base station newly linked with the user equipment and whether the target base station provides the MBMS through a dedicated radio bearer or a radio bearer (MRB) for the MBMS, from the source base station, and to receive the MBMS from the target base station.

2. The user equipment of claim 1, wherein the transmitting unit transmits the MBMS service indication further including a flag identifying whether the user equipment receives the MBMS from the source base station, to the source base station.

3. The user equipment of claim 1, wherein the transmitting unit transmits the MBMS service indication further including a temporary mobile group identity (TMGI) for the MBMS, which identifies a type of the MBMS, to the source base station.

4. The user equipment of claim 1, wherein the transmitting unit transmits the MBMS service indication to the source base station by using a measurement reporting message used in a procedure of the handover.

5. A method for receiving a multimedia broadcast multicast service (MBMS), comprising:
transmitting an MBMS service indication including at least one of configuration information representing a configuration of an MBMS subframe, which is a subframe in which a user equipment receives the MBMS in a radio frame, information regarding MBMS single frequency network (MBSFN) area, and information regarding a physical multicast channel (PMCH), which is a physical channel through which the MBMS is transmitted, to a source base station linked with the user equipment;
receiving an MBMS service response indication indicating whether the MBMS is supported from a target base station newly linked with the user equipment and whether the target base station provides the MBMS through a dedicated radio bearer or a radio bearer (MRB) for the MBMS, from the source base station; and
receiving the MBMS from the target base station.

6. The method of claim 5, wherein the MBMS service indication further includes a flag identifying whether the user equipment receives the MBMS from the source base station.

7. The method of claim 5, wherein the MBMS service indication further includes a temporary mobile group identity (TMGI) for the MBMS, which identifies a type of the MBMS.

8. The method of claim 5, wherein the MBMS service indication is transmitted to the source base station by using a measurement reporting message used in a procedure of the handover.

9. A target base station to transmit a multimedia broadcast multicast service (MBMS) comprising:
a receiving unit to receive an MBMS control request indication including information representing whether a user equipment receives the MBMS and information regarding a type of the MBMS, from a source base station linked with the user equipment;
a control unit to judge whether to continuously support the MBMS to the user equipment based on the MBMS control request indication and to determine whether to transmit the MBMS through a radio bearer for the MBMS; and
a transmitting unit to transmit an MBMS service start indication indicating that the MBMS is supported to the user equipment and to transmit the MBMS under the same condition as the source base station.

10. The target base station of claim 9, wherein the receiving unit receives the MBMS control request indication further including MBMS interest information representing a type of the MBMS and interest or not for each type, from the source base station, and the control unit preferentially configures an MBMS of a type indicated to be interested by the MBMS interest information as a radio bearer for the MBMS.

11. The target base station of claim 9, wherein the MBMS control request indication further includes at least one of configuration information representing a configuration of an MBMS subframe, which is a subframe providing the MBMS in a radio frame, information regarding MBMS single frequency network (MBSFN) area, and information regarding a physical multicast channel (PMCH), which is a physical channel through which the MBMS is transmitted.

12. The target base station of claim 11, wherein the control unit judges whether at least one of the configuration information, the information regarding the MBSFN area, and the information regarding the PMCH is the same between the source station and the target base station.

13. A method for transmitting a multimedia broadcast multicast service (MBMS) by a target base station, comprising:
receiving an MBMS control request indication including information representing whether a user equipment receives the MBMS and information regarding a type of the MBMS, from a source base station linked with the user equipment;
judging whether to continuously support the MBMS to the user equipment based on the MBMS control request indication;
determining whether to transmit the MBMS through a radio bearer for the MBMS;
transmitting an MBMS service start indication indicating that the MBMS is supported to the user equipment; and
transmitting the MBMS under the same condition as the source base station.

14. The method of claim 13, wherein in the judging, it is judged whether to support the MBMS through a cell at the same frequency band as a cell at a frequency band in the source base station.

15. The method of claim 13, wherein the MBMS control request indication further includes at least one of configuration information representing a configuration of an MBMS subframe, which is a subframe providing the MBMS in a radio frame, information regarding MBMS single frequency network (MBSFN) area, and information regarding a physical multicast channel (PMCH), which is a physical channel through which the MBMS is transmitted.

16. The method of claim 15, wherein in the judging, it is judged whether at least one of the configuration information, the information regarding the MBSFN area, and the information regarding the PMCH is the same between the source station and the target base station.

17. A method for transmitting a multimedia broadcast multicast service (MBMS) by a source base station, comprising:
receiving an MBMS service indication including at least one of configuration information representing a configuration of an MBMS subframe, which is a subframe in which a user equipment receives the MBMS in a radio frame, information regarding a single frequency network (MBSFN) area, and information regarding a physical multicast channel (PMCH), which is a physical channel through which the MBMS is transmitted, from the user equipment;
transmitting an MBMS control request indication requesting continuity of the MBMS to a target base station newly linked with the user equipment, to the target base station as a response to the MBMS service indication;
receiving an MBMS service start indication indicating whether to support the continuity of the MBMS from the target base station; and
transmitting an MBMS service response indication indicating whether the MBMS is supported in the target base station to the user equipment as a response to the MBMS service indication.

18. The method of claim 17, wherein the MBMS control request indication further includes MBMS interest information indicating whether the user equipment takes an interest in receiving the MBMS.

19. The method of claim 17, wherein the MBMS control request indication further includes MBMS interest information representing a type of the MBMS and an interest or not for each type.

20. A source base station transmitting a multimedia broadcast multicast service (MBMS), comprising:
a source receiving unit to receive an MBMS service indication including at least one of configuration information representing a configuration of an MBMS subframe, which is a subframe in which a user equipment receives the MBMS in a radio frame, information regarding a single frequency network (MBSFN) area, and information regarding a physical multicast channel (PMCH), which is a physical channel through which the MBMS is transmitted, from the user equipment; and
a source transmitting unit to transmit an MBMS control request indication requesting continuity of the MBMS to a target base station newly linked with the user equipment, to the target base station, and to transmit an MBMS service response indication indicating whether the MBMS is supported in the target base station to the user equipment,
wherein the source receiving unit receives an MBMS service start indication indicating whether to support of the MBMS, from the target base station.

21. The source base station of claim 20, wherein the source transmitting unit transmits the MBMS control request indication further including MBMS interest information indicating whether the user equipment takes an interest in receiving the MBMS, to the target base station.

22. The source base station of claim 20, wherein the source transmitting unit transmits the MBMS control request indication further including MBMS interest information representing a type of the MBMS and interest or not for each type, to the target base station.
